(19) United States
(12) Patent Application Publication
(10) Pub. No.: US 2005/0182587 A1
(43) Pub. Date: Aug. 18, 2005

(54) Circuit quality evaluation method and apparatus, circuit quality evaluation program, and medium having the program recorded thereon

(75) Inventors: Yasuo Sato, Tokyo (JP); Shuji Hamada, Kawasaki-shi (JP); Toshiyuki Maeda, Kawasaki-shi (JP); Atsuo Takatori, Kawasaki-shi (JP); Yasuyuki Nozuyama, Tokyo (JP)

Correspondence Address: STAAS & HALSEY LLP, SUITE 700, 1201 NEW YORK AVENUE, N.W., WASHINGTON, DC, 20005, US

(73) Assignee: SEMICONDUCTOR TECHNOLOGY ACADEMIC RESEARCH CENTER, Yokohama-shi (JP)

(21) Appl. No.: 11/052,908

(22) Filed: Feb. 9, 2005

(30) Foreign Application Priority Data
Feb. 13, 2004 (JP) 2004-37395
Mar. 30, 2004 (JP) 2004-100039

(51) Int. Cl. G06F 19/00

(52) U.S. Cl. 702/117

(57) ABSTRACT

A circuit quality evaluation method obtains an indicator linked to the quality of a circuit by applying information representing a minimum delay margin of a path passing through an assumed fault site, a machine cycle, and a delay fault occurrence frequency. Further, the circuit quality evaluation method evaluates the quality of the circuit based on the indicator.

### CROSS REFERENCE TO RELATED APPLICATION

This application is based upon and claims the benefit of priority from the prior Japanese Patent Application No. 2004-037395 filed on Feb. 13, 2004 and No. 2004-100039 filed on Mar. 30, 2004, the entire contents of which are incorporated herein by reference.

### BACKGROUND OF THE INVENTION

1. Field of the Invention

The present invention relates to a circuit quality evaluation method and apparatus, a circuit quality evaluation program, and a medium having the program recorded thereon, and more particularly to a technique for performing quality evaluation by obtaining delay quality indicators for semiconductor integrated circuits.

2. Description of the Related Art

In recent years, with decreasing feature sizes and increasing operating frequencies of semiconductor integrated circuits (LSIs), defects due to delay faults in LSIs have been increasing. An indicator for indicating the delay quality of an LSI is therefore needed. LSI testing is applied in order to eliminate manufacturing defects of LSIs, and includes, for example, a delay test which is a test for detecting defects due to LSI delays.

This kind of testing is applied by using a design-for-testability technique called “scan design” (scan path design) in which flip-flops are connected in a chain in such a manner as to enable the values of the flip-flops to be set and observed from external inputs and outputs, and the values are shifted through the scan path from an external terminal by using a scan shift that causes the values to be input to and output from the scan chain. Here, a flip-flop is generally used in an LSI as a storage device that is capable of holding information either a 0 or a 1, which is latched into it when a clock is applied; latching a value into a flip-flop is called “capturing”.

In the prior art, several proposals have been made to indicate the quality of LSIs by using indicators (fault coverage, etc.) but the indicators proposed in the prior have not been related to the delay defect level of LSIs, nor have they been made to reflect the timing margin distribution (design margin) of design or to reflect test timing accuracy, and there have been even cases where the same indicator value indicates different levels of delay quality; for these and other reasons, the prior art indicators have been unable to produce satisfactory results.

Under these circumstances, there has developed a need to provide a technique that evaluates the quality of an LSI by obtaining an indicator that can reflect the actual market failure rate (that is, defect level) by comprehensively evaluating the quality of the manufacturing process, the delay margin of the design, and the test accuracy, rather than provide, as an indicator for indicating the delay quality of an LSI, a fault model that evaluates the logic coverage of test vectors, as traditionally practiced. Here, the fault coverage is an indicator that indicates the quality of a test pattern, and is generally obtained as [Fault coverage]=[Number of detected faults]/[Number of assumed faults].

A fault simulator which computes the fault coverage, etc. for output means a program (or a computer that executes the program) that takes circuit logic connection information and a test pattern as inputs and performs simulation using a circuit assumed to contain faults, to evaluate whether the faults have been detected successfully. The test pattern is a pattern that is input to test an LSI, and such test patterns may be generated manually; in practice, however, because of large circuit scale, an automatic test pattern generator (ATPG) is generally used.

As described above, traditionally the fault coverage (indicator) that evaluates the coverage of test patterns has been used as an indicator for a fault associated with a signal delay in a logic LSI.

In the prior art, a semiconductor integrated circuit quality evaluation method that obtains indicators by taking as inputs the values equivalent to the minimum delay margin (Tmgn) of a path passing through an assumed fault site, the machine cycle (MC), the test cycle (TC), and the minimum delay value of a detected delay fault, is disclosed, for example, in U.S. Patent Published Application No. 2003/0204350 (corresponding to U.S. Pat. No. 6,708,139).

Further, in the prior art, a semiconductor integrated circuit quality evaluation method that obtains indicators by taking as inputs the values equivalent to the minimum delay margin of a path passing through an assumed fault site, the test cycle, and the minimum delay value of a detected delay fault, is disclosed, for example, in a paper by Vijay S. Iyengar et al., entitled “Delay Test Generation 1 —Concept and Coverage Metrics,” U.S.A., IBM Research Division, International Test Conference 1988, pp. 857-864.

Also, a semiconductor integrated circuit quality evaluation method that obtains indicators by taking as inputs the frequency of delay fault occurrence and the values equivalent to the minimum delay margin of a path passing through an assumed fault site, the test cycle, and the minimum delay value of a detected delay fault, is disclosed in the prior art, for example, in a paper by Ankan K. Pramanick et al., entitled “On the Detection of Delay Faults,” U.S.A., Department of Electrical & Computer Engineering University of Iowa, International Test Conference 1988, pp. 845-856.

Furthermore, in the prior art, a semiconductor integrated circuit quality evaluation method that uses a fault model called a multiple-threshold gate-delay fault model, and that divides assumed fault sites into groups by the size of the detected delay fault and obtains the coverage rate for each group, is disclosed, for example, in a paper by Michinobu Nakao et al., entitled “High Quality Delay Test Generation Based on Multiple-Threshold Gate-Delay Fault Model,” Japan, IEICE TRANS. INF. & SYST., Vol. E85-D, No. 10 Oct. 2002.

The prior art and its associated problems will be described in detail later with reference to accompanying drawings.

### SUMMARY OF THE INVENTION

An object of the present invention is to provide a circuit quality evaluation technique that reflects the actual market failure rate.

According to the present invention, there is provided a circuit quality evaluation method which obtains an indicator linked to the quality of a circuit by applying information representing a minimum delay margin of a path passing through an assumed fault site, a machine cycle, and a delay fault occurrence frequency, and evaluates the quality of the circuit based on the indicator.

The indicator may be obtained by further applying test accuracy information, that is the indicator may be obtained by further applying information on test accuracy. The test accuracy information may include a minimum delay value (that is, the minimum delay size) of a detected delay fault for the fault site. The test accuracy information may include a test cycle for the fault site.

A plurality of the fault sites may be assumed, and the same machine cycle and the same test cycle may be used for the plurality of assumed fault sites. A plurality of the fault sites may be assumed, and a plurality of the machine cycles and a plurality of the test cycles may be used for the plurality of assumed fault sites.

An indicator linked to the quality of the circuit as a whole may be obtained by summing the indicators computed for the plurality of assumed fault sites, and an indicator linked to the quality of the circuit per assumed fault site may be obtained by taking an average of the indicators. The indicators may be obtained by taking account of variation in the minimum delay margin of the path passing through the assumed fault site. An approximation to each of the indicators may be obtained by using a multiple-threshold fault simulator.

Further, according to the present invention, there is provided a circuit quality evaluation method comprising the steps of applying circuit design information, a test pattern, clock domain information, and test clock domain information; assuming a delay fault at a given site within a circuit; calculating a minimum delay margin of a path passing through the assumed delay fault site; calculating a minimum delay fault value detected on the path passing through the assumed delay fault site; updating a fault table; and obtaining a delay quality indicator by applying the updated fault table and a delay fault occurrence frequency, wherein the quality of the circuit is evaluated by estimating an actual market failure rate from the value of the obtained delay quality indicator.

The updating of the fault table may be done by updating a minimum delay size of a detected delay fault and a test cycle during execution of a fault simulator. The clock domain information may include a fixed machine cycle, and the test clock domain information may include the updated test cycle. The delay fault may be assumed at a plurality of sites, and the same machine cycle and the same test cycle may be used for the plurality of assumed delay fault sites. The delay fault may be assumed at a plurality of sites, and a plurality of the machine cycles and a plurality of the test cycles may be used for the plurality of assumed delay fault sites.

An indicator linked to the quality of the circuit as a whole may be obtained by summing the delay quality indicators computed for the plurality of assumed delay fault sites, and a delay quality indicator linked to the quality of the circuit per assumed fault site may be obtained by taking an average of the delay quality indicators. The delay quality indicators may be obtained by taking account of variation in the minimum delay margin of the paths passing through the plurality of assumed delay fault sites. An approximation to each of the delay quality indicators may be obtained by using a multiple-threshold fault simulator.

The test pattern may be fed back by using the delay quality indicator. The circuit quality evaluation method may further comprise the steps of selecting a fault for which the delay quality indicator is large; and

generating a test pattern by focusing attention on the selected fault, and feeding back the generated test pattern to the information applying step.

Feedback may be applied to each design flow process by using the delay quality indicator. The delay quality indicator may be fed as a constrained parameter or an optimization parameter to an RTL design step, a logic synthesis step, a netlist generation step, or a layout design step.

According to the present invention, there is also provided a circuit quality evaluation apparatus which obtains an indicator linked to the quality of a circuit by applying information representing a minimum delay margin of a path passing through an assumed fault site, a machine cycle, and a delay fault occurrence frequency, and evaluates the quality of the circuit based on the indicator.

Further, according to the present invention, there is provided a circuit quality evaluation apparatus comprising a unit for applying circuit design information, a test pattern, clock domain information, and test clock domain information; a unit for assuming a delay fault at a given site within a circuit; a unit for calculating a minimum delay margin of a path passing through the assumed delay fault site; a unit for calculating a minimum delay fault value detected on the path passing through the assumed delay fault site; a unit for updating a fault table; and a unit for obtaining a delay quality indicator by applying the updated fault table and a delay fault occurrence frequency, wherein the quality of the circuit is evaluated by estimating an actual market failure rate from the value of the obtained delay quality indicator.

In addition, according to the present invention, there is provided a circuit quality evaluation program comprising the steps of applying circuit design information, a test pattern, clock domain information, and test clock domain information; assuming a delay fault at a given site within a circuit; calculating a minimum delay margin of a path passing through the assumed delay fault site; calculating a minimum delay fault value detected on the path passing through the assumed delay fault site; updating a fault table; and obtaining a delay quality indicator by applying the updated fault table and a delay fault occurrence frequency, wherein the quality of the circuit is evaluated by estimating an actual market failure rate from the value of the obtained delay quality indicator.

Furthermore, according to the present invention, there is also provided a computer readable recording medium having a circuit quality evaluation program recorded thereon, the program comprising the steps of applying circuit design information, a test pattern, clock domain information, and test clock domain information; assuming a delay fault at a given site within a circuit; calculating a minimum delay margin of a path passing through the assumed delay fault site; calculating a minimum delay fault value detected on the path passing through the assumed delay fault site; updating a fault table; and obtaining a delay quality indicator by applying the updated fault table and a delay fault occurrence frequency, wherein the quality of the circuit is evaluated by estimating an actual market failure rate from the value of the obtained delay quality indicator.

### BRIEF DESCRIPTION OF THE DRAWINGS

The present invention will be more clearly understood from the description of the preferred embodiments as set forth below with reference to the accompanying drawings, wherein:

FIG. 1 is a diagram for schematically explaining examples of indicators used in semiconductor integrated circuit quality evaluation methods according to the prior art;

FIG. 2 is a diagram for explaining an indicator used in a first example of the prior art semiconductor integrated circuit quality evaluation method;

FIG. 3 is a diagram for explaining a problem associated with the first example of the prior art semiconductor integrated circuit quality evaluation method;

FIG. 4 is a diagram for explaining indicators used in a second example of the prior art semiconductor integrated circuit quality evaluation method, along with a problem associated with it;

FIG. 5 is a diagram for explaining indicators used in a third example of the prior art semiconductor integrated circuit quality evaluation method, along with a problem associated with it;

FIG. 6 is a diagram for explaining an input/output on a circuit quality evaluation apparatus according to the present invention;

FIGS. 7A and 7B are diagrams respectively showing one example of a path timing margin distribution obtained from a design information file in FIG. 6 and one example of a delay fault distribution obtained from the frequency of delay fault occurrence;

FIG. 8 is a diagram showing an example of calculation on an actual circuit, for explaining a circuit quality evaluation method according to the present invention;

FIG. 9 is a diagram for schematically explaining an example of an indicator used in the circuit quality evaluation method according to the present invention;

FIG. 10 is a diagram showing a table presenting comparisons between the circuit quality evaluation method according to the present invention and the circuit quality evaluation method according to the prior art;

FIG. 11 is a diagram showing one example of a transition delay fault model in a circuit;

FIG. 12 is a diagram showing one example of a circuit with the transition delay fault model shown in FIG. 11;

FIG. 13 is a diagram showing one example of a tested path in the circuit of FIG. 12;

FIG. 14 is a diagram showing, by way of example, a clock waveform during system operation and a clock waveform during test operation;

FIG. 15 is a diagram showing an example of a signal waveform in the absence of a fault (that is, in fault free);

FIG. 16 is a diagram showing a first example of a signal waveform in the presence of a delay fault;

FIG. 17 is a diagram showing a second example of a signal waveform in the presence of a delay fault;

FIG. 18 is a diagram showing a third example of a signal waveform in the presence of a delay fault;

FIG. 19 is a diagram for explaining a delay quality indicator used in the circuit quality evaluation method according to the present invention;

FIG. 20 is a diagram for explaining the delay quality indicator when path delay variation in the circuit is taken into account;

FIG. 21 is a diagram showing one example of a fault table in the circuit quality evaluation method according to the present invention;

FIG. 22 is a diagram showing a flowchart for explaining one example of the circuit quality evaluation operation according to the present invention;

FIG. 23 is a diagram for explaining how test timing is changed in the circuit quality evaluation method according to the present invention;

FIG. 24 is a diagram showing one example of a fault table for a single-clock circuit in the circuit quality evaluation method according to the present invention;

FIG. 25 is a diagram showing one example of a fault table for a multi-clock circuit in the circuit quality evaluation method according to the present invention;

FIGS. 26A, 26B, and 26C are diagrams showing one example of correspondence between the fault table and the clock domain information and test clock domain information in the circuit quality evaluation method according to the present invention;

FIG. 27 is a diagram showing one example of the multi-clock circuit in the circuit quality evaluation method according to the present invention;

FIGS. 28A and 28B are diagrams each showing an example of a path distribution in an evaluation circuit in the circuit quality evaluation method according to the present invention;

FIG. 29 is a diagram for explaining the delay quality indicator obtained in the circuit quality evaluation method according to the present invention;

FIG. 30 is a diagram for explaining an example of a multiple-threshold fault model;

FIG. 31 is a diagram for explaining one example of a method of obtaining the frequency of delay fault occurrence;

FIGS. 32A, 32B, and 32C are diagrams explaining another example of the method of obtaining the frequency of delay fault occurrence;

FIG. 33 is a diagram for explaining one example of test pattern generation that uses the delay quality indicator obtained in the circuit quality evaluation method according to the present invention;

FIG. 34 is a diagram conceptually showing one example of a design flow according to the prior art;

FIG. 35 is a diagram for explaining one example of a design flow that uses the delay quality indicator obtained in the circuit quality evaluation method according to the present invention; and

FIG. 36 is a diagram for explaining an example of a medium having a circuit quality evaluation program recorded thereon according to the present invention.

### DESCRIPTION OF THE PREFERRED EMBODIMENTS

Before describing the embodiments of the present invention in detail, prior art quality evaluation techniques for semiconductor integrated circuits (circuits) and their associated problems will be described first.

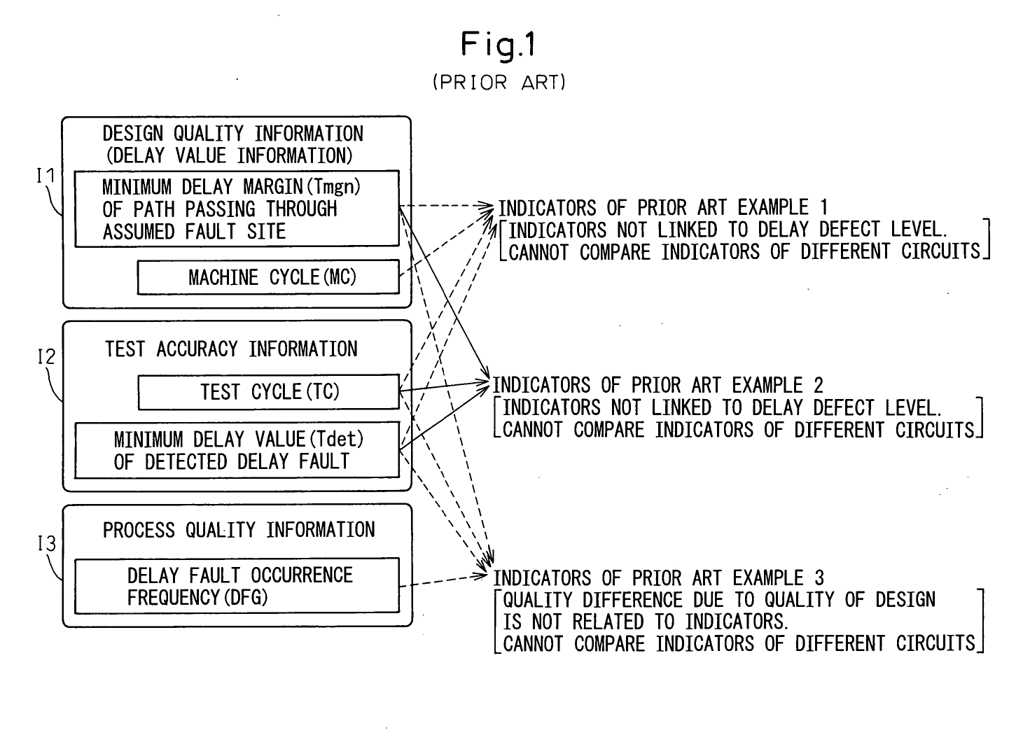

FIG. 1 is a diagram for schematically explaining examples of indicators used in the prior art semiconductor integrated circuit (circuit) quality evaluation methods. In FIG. 1, reference character I1 indicates design quality information (delay value information) which includes information representing the machine cycle MC and the minimum delay margin (Tmgn) of a path passing through an assumed fault site, I2 indicates test accuracy information which includes information representing the test cycle TC and the minimum delay value (that is, the minimum delay size) Tdet of a detected delay fault, and I3 indicates process quality information which includes information representing the frequency of delay fault occurrence DFG. Here, the machine cycle MC refers to circuit operating speed, design specification operating speed, flip-flop clock cycle during system operation, etc. and the test cycle (test timing) TC refers to capture timing during test operation. Because of such constraints as tester speeds and design-for-testability circuits, the machine cycle MC often does not coincide with the test cycle TC.

As shown in FIG. 1, there are proposed in the prior art: a semiconductor integrated circuit quality evaluation method that obtains indicators by taking as inputs the values equivalent to the minimum delay margin Tmgn of a path passing through an assumed fault site, the machine cycle MC, the test cycle TC, and the minimum delay value Tdet of a detected delay fault (Prior art example 1: Refer, for example, to U.S. Patent Published Application No. 2003/0204350); a semiconductor integrated circuit quality evaluation method that obtains indicators by taking as inputs the values equivalent to the minimum delay margin Tmgn of a path passing through an assumed fault site, the test cycle TC, and the minimum delay value Tdet of a detected delay fault (Prior art example 2: Refer, for example, to, a paper by Vijay S. Iyengar et al., entitled “Delay Test Generation 1—Concept and Coverage Metrics,” U.S.A., IBM Research Division, International Test Conference 1988, pp. 857-864); and a semiconductor integrated circuit quality evaluation method that obtains indicators by taking as inputs the frequency of delay fault occurrence DFG and the values equivalent to the minimum delay margin Tmgn of a path passing through an assumed fault site, the test cycle TC, and the minimum delay value Tdet of a detected delay fault (Prior art example 3: Refer, for example, to a paper by Ankan K. Pramanick et al., entitled “On the Detection of Delay Faults,” U.S.A., Department of Electrical & Computer Engineering University of Iowa, International Test Conference 1988, pp. 845-856).

Furthermore, in the prior art, there is also proposed a semiconductor integrated circuit quality evaluation method that uses a fault model called a multiple-threshold gate-delay fault model, and that divides assumed fault sites into groups by the size of the detected delay fault and obtains the coverage rate for each group (Prior art example 4: Refer, for example, to a paper by Michinobu Nakao et al., entitled “High Quality Delay Test Generation Based on Multiple-Threshold Gate-Delay Fault Model,” Japan, IEICE TRANS. INF. & SYST., Vol. E85-D, No. 10 Oct. 2002).

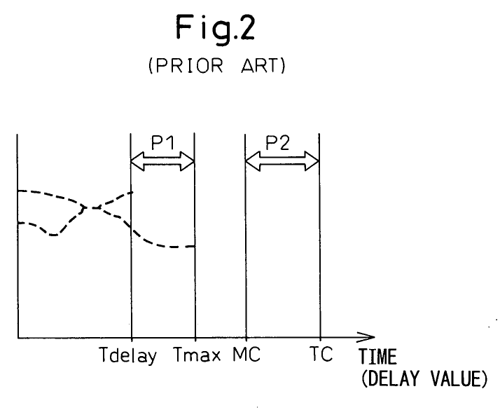

FIG. 2 is a diagram for explaining one of the indicators used in the first example of the prior art semiconductor integrated circuit quality evaluation method, i.e. the first prior art example described above.

In the first prior art example, an indicator DDE (Delay Defect Exposure) for each fault is expressed by the following equation.
DDE=P1+P2=(Tmax−Tdelay)+(TC−TM)
Tmax: Delay value of longest path (≅TC−Tmgn)
Tdelay: Delay value of tested path (=TC−Tdet)

This shows that the closer to 0 the indicator DDE is (DDE [symbol] 0), the higher the quality of the LSI. However, this prior art indicator DDE is not one that quantifies the actual quality of the LSI, and falls far short of sufficing the purpose when it comes to estimating the level of the actual market failure rate (delay defect level).

Further, the other indicator DSR (Delay Sensitivity Ratio) for each fault in the first prior art example is expressed by the following equation.
DSR=Tdelay/Tmax

Accordingly, the indicator DSR is 0≦DSR≦1, which shows that the closer to 1 the indicator DSR is (DSR [symbol] 1), the higher the quality of the LSI. However, this prior art indicator DSR only indicates the quality difference in relative terms, and while it is proposed to take the sum of DSRs for individual faults in the LSI as the indicator for the entire LSI, this indicator cannot be related to the delay defect level in the market.

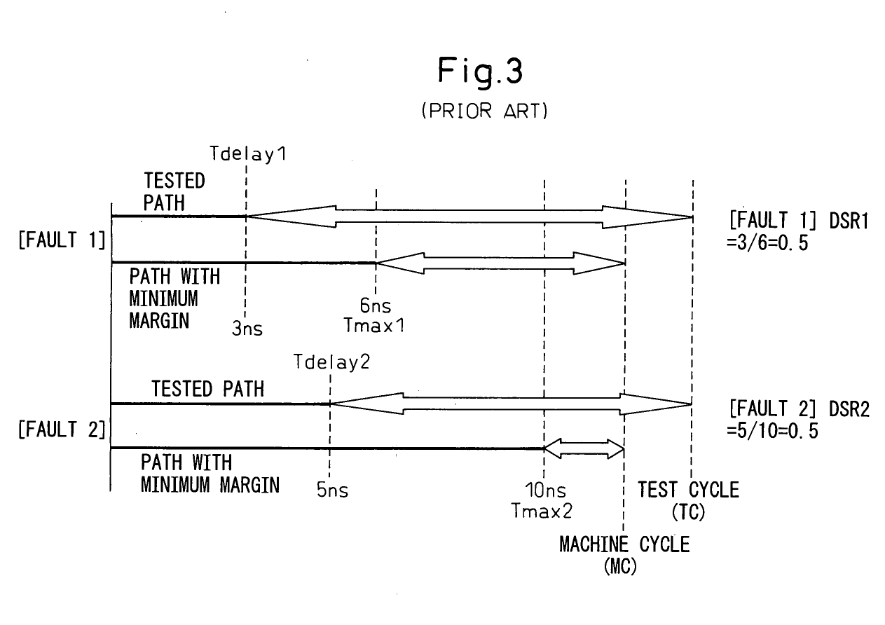

FIG. 3 is a diagram for explaining the problem associated with the first example of the prior art semiconductor integrated circuit quality evaluation method.

As show in FIG. 3, since the other indicator DSR in the first prior art example is expressed as DSR=Tdelay/Tmax, as described above, the value of the indicator DSR1 ( 3/6=0.5) when the delay value of the longest path, Tmax1, is 6 ns and the delay value of the tested path, Tdelay1, is 3 ns, as in [Fault 1], for example, becomes the same as the value of the indicator DSR2 ( 5/10=0.5) when the delay value of the longest path, Tmax2, is 10 ns and the delay value of the tested path, Tdelay2, is 5 ns, as in [Fault 2]. However, it is apparent that the delay defect level in the actual market is different between [Fault 1] and [Fault 2] though the value of the indicator DSR is the same, and therefore, this indicator DSR is obviously not suitable as the indicator.

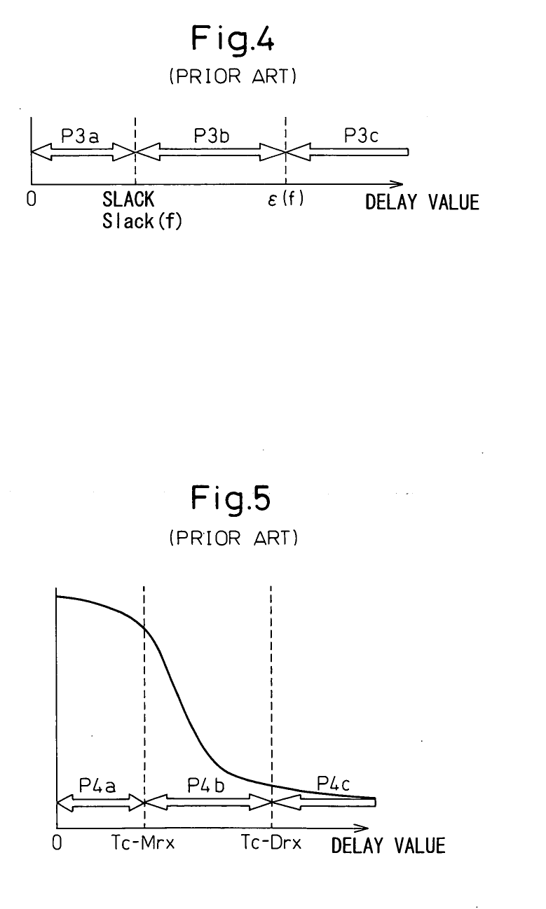

FIG. 4 is a diagram for explaining the indicators used in the second example of the prior art semiconductor integrated circuit quality evaluation method, i.e., the second prior art example described above, along with the problem associated with it. In FIG. 4, the area indicated by reference character P3a is a fault that need not be detected (because of sufficient timing margin), while the areas indicated by reference characters P3b and P3c are faults that need to be detected; here, the area of P3c is the fault that was actually detected by a delay test pattern.

In the second prior art example, an indicator DQ(f) for each fault is expressed by the following equation using the slack(f) (corresponding to the time margin Tmgn allowed in the LSI) of the fault path and the actually detected timing ε(f).
DQ(f)=Slack(f)/ε(f)

Here, the path slack is a value obtained by subtracting the path length from the clock timing TC, that is, it corresponds to the path's timing margin (time margin Tmgn).

Further, an indicator TQ for the entire LSI is expressed by the following equation when the detected fault set is denoted by Fd. In the following equation, |Fd| represents the number of detected faults.

$$TQ = \frac{1}{\vert Fd \vert} {\sum }_{f ɛ Fd} DQ ( f )$$

Accordingly, the indicator TQ is 0≦TQ≦1, which shows that the closer to 1 the indicator TQ is (TQ [symbol] 1), the higher the quality of the LSI. However, while the indicator DQ(f) for each fault is 0≦DQ(f)≦1, this indicator DQ(f) only indicates the quality difference in relative terms, and therefore, the indicator TQ also cannot be related to the delay defect level in the market.

FIG. 5 is a diagram for explaining the indicators used in the third example of the prior art semiconductor integrated circuit quality evaluation method, i.e., the third prior art example described above, along with the problem associated with it. In FIG. 5, reference character P4a indicates an area where the amount of delay is from zero to TC-Mrx, P4b indicates an area where the amount of delay is from TC-Mrx to TC-Drx, and P4cindicates an area where the amount of delay is larger than TC-Drx. Here, TC is the test cycle, Mrx is the path length when transition “x” is made on line “r”, and Drx is the path length when transition “x” is made on line “r” in a given test vector.

The potentially achievable fault coverage (integral over the areas P4b+P4c in FIG. 5, i.e., an indicator) PAFC and the fault coverage (integral over the area P4cin FIG. 5, i.e., an indicator) FC are respectively given by the following equations, where Max is the maximum amount of the delay possible (∞ would cause a problem) and Prx(s) is the fault size distribution function.

$$\begin{matrix} PAFC = {\int }_{TC \text{-} Mrx}^{Max} {P}_{rx} ( s ) ⅆ s \\ FC = {\int }_{TC \text{-} Drx}^{Max} {P}_{rx} ( s ) ⅆ s \end{matrix}$$

However, these indicators PAFC and FC do not incorporate the concept of machine cycle MC; besides, since there are two indicators, the problem is that the quality of the entire circuit cannot be measured using a single indicator.

In this way, while the prior art fault coverage (indicators) reflect test vector quality, any of the prior art indicators has been incomplete when it comes to estimating the level of the actual market failure rate (that is, defect level), since no account has been taken of test accuracy or process quality. Further, the first to third prior art examples that use the design quality information I1, test accuracy information I2, and process quality information I3 previously described with reference to FIG. 1 have been proposed to estimate the actual market failure rate, but the indicators obtained in the first to third prior art examples have not been able to provide sufficient means for estimating the level of the actual market failure rate.

That is, the prior art quality evaluation techniques for semiconductor integrated circuits have had the problems that only the fault coverage is provided and its relationship with the failure rate is not defined, that it is difficult to compare quality between different products, and that accumulated data on the frequency of defect occurrence on a production line cannot be linked to the improvement of accuracy. Furthermore, the prior art quality evaluation techniques for semiconductor integrated circuits are not intended to provide an indicator that reflects the quality of the design (the design margin) and quantify the relationship that a product having a larger margin is less prone to failure. Moreover, the prior art quality evaluation techniques for semiconductor integrated circuits are not intended to quantify the relationship between the improvement of timing accuracy and the improvement of quality, because in the prior art the coverage rate does not change if the test timing changes.

The present invention will be described in detail below with reference to the accompanying drawings.

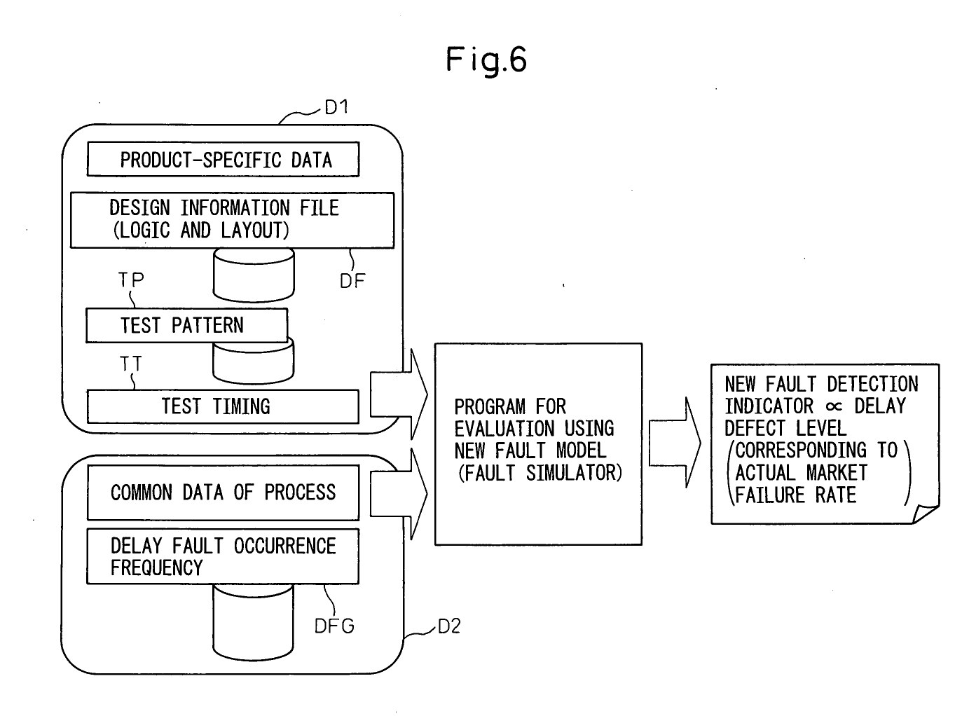

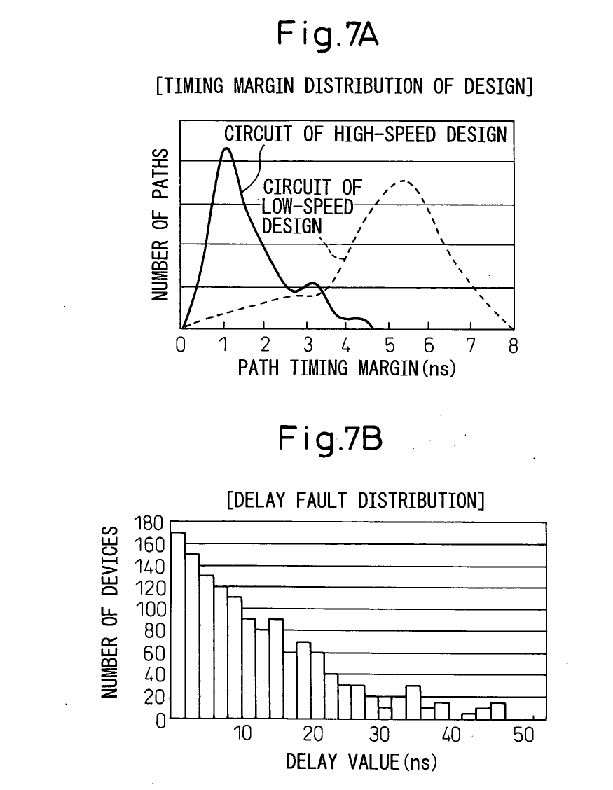

FIG. 6 is a diagram for explaining an input/output on a circuit quality evaluation apparatus according to the present invention, and FIGS. 7A and 7B are diagrams respectively showing one example of a path timing margin distribution obtained from a design information file in FIG. 6 and one example of a delay fault distribution obtained from the frequency of delay fault occurrence. Here, FIG. 7A shows one example of the path timing margin distribution (path slack distribution) obtained from the design information file (that is, netlist, or logic and layout) DF, and FIG. 7B shows one example of the delay fault distribution (delay fault occurrence frequency) obtained from the delay fault occurrence frequency DFG. In FIG. 7A, the abscissa in the graph showing the timing margin distribution of design represents the slack [ns] corresponding to the path timing margin (time margin Tmgn); for example, when the design margin is small as in 200-MHz design, the number of paths whose slack (timing margin) is 2 ns or less increases, and conversely, when the design margin is large as in 100-MHz design, the number of paths having relatively large slacks of about 2 to 6 ns increases.

As shown in FIG. 6, the circuit quality evaluation apparatus (fault simulator: an evaluation program using a new fault model) of the present invention receives the design information file DF, test pattern TP, and test timing TT contained in product-specific data D1 and the delay fault occurrence frequency DFG contained in common data D2 of the process, and outputs a new fault detection indicator (delay quality indicator). The delay quality indicator obtained by the present invention yields a value proportional to the delay defect level corresponding to the actual market failure rate, and therefore, the actual market failure rate can be estimated from the value of the delay quality indicator.

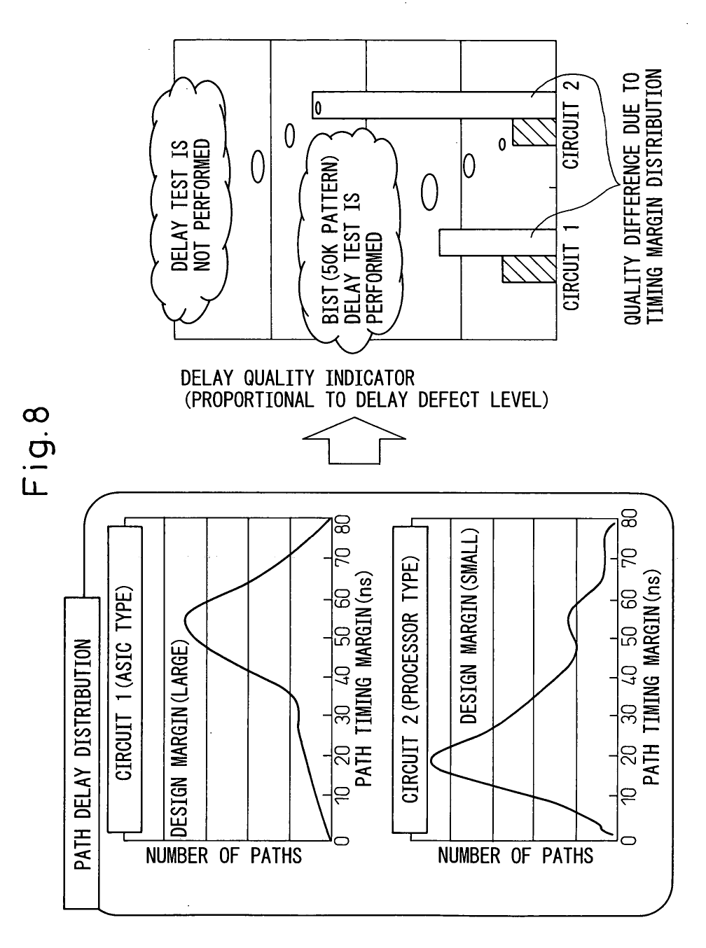

FIG. 8 is a diagram showing an example of calculation on an actual circuit, for explaining a circuit quality evaluation method according to the present invention. As in FIG. 7A, the abscissa in the graph showing the path delay distribution at the left of FIG. 8 represents the slack [ns] corresponding to the path timing margin Tmgn.

As shown in FIG. 8, when a circuit 1 (for example, an ASIC-type circuit) having a large design margin and a circuit 2 (for example, a processor-type circuit) having a small design margin are considered, if delay testing is not applied, the actual market failure rate of the circuit 2 having the smaller design margin becomes much larger than that of the circuit 1 having the larger design margin. For example, if the circuits 1 and 2 have signal delay faults of the same size (for example, faults with a delay value of 20 ns), the probability of circuit failure is higher in the circuit 2 having the smaller design margin, since the proportion of the paths whose margin is 20 ns or less is larger. That is, if delay testing is not applied, the delay quality indicator (proportional to the delay defect level) for the circuit 2 becomes larger than the delay quality indicator for the circuit 1 because of the quality difference arising from the difference in design margin.

On the other hand, if delay testing (for example, BIST (50K pattern) delay testing) is done, the delay quality indicator of the present invention becomes sufficiently small for both the circuit 1 and the circuit 2, as shown by hatching in the graph at the right of FIG. 8. That is, since LSIs rendered defective by the delay testing are not shipped to the market, the actual market failure rate decreases.

In this way, according to the present invention, not only can the indicator proportional to the actual market failure rate (delay defect level) be provided, but it also becomes possible to compare quality between different products; furthermore, the accuracy can be enhanced by accumulating data of the defect occurrence frequency for a production line. Further, according to the present invention, since the indicator that reflects the design margin can be provided, it becomes possible to quantify the relationship that a product having a larger margin is less prone to failure. Moreover, according to the present invention, the indicator that reflects the accuracy of test timing can be provided, and since the value of the indicator changes with the test cycle (frequency), it becomes possible to quantify the relationship between the improvement of test accuracy and the improvement of quality.

Hereinafter, the circuit quality evaluation technique of the present invention will be described primarily by taking the quality evaluation of a semiconductor integrated circuit (LSI) as an example, but the present invention can be applied not only to semiconductor integrated circuits constructed by packaging semiconductor chips, but can also be applied extensively to semiconductor chips (dies) formed on a wafer or multi-chip modules, circuit boards, etc. on which a plurality of semiconductor integrated circuits are formed.

In this way, according to the present invention, the circuit quality evaluation technique can be provided that reflects the actual market failure rate.

Before describing in detail the embodiments of the quality evaluation apparatus and quality evaluation method for a circuit (semiconductor integrated circuit) according to the present invention, the basic concept of the present invention will be described first.

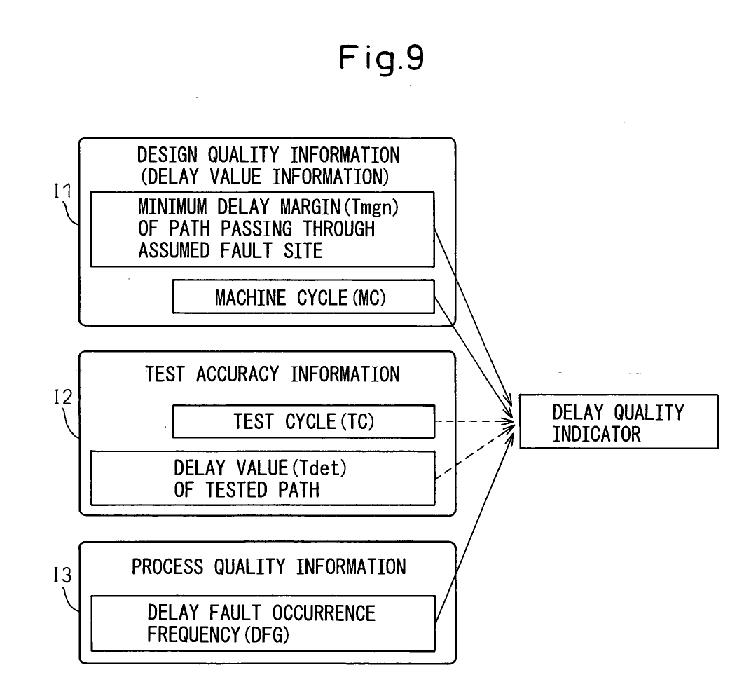

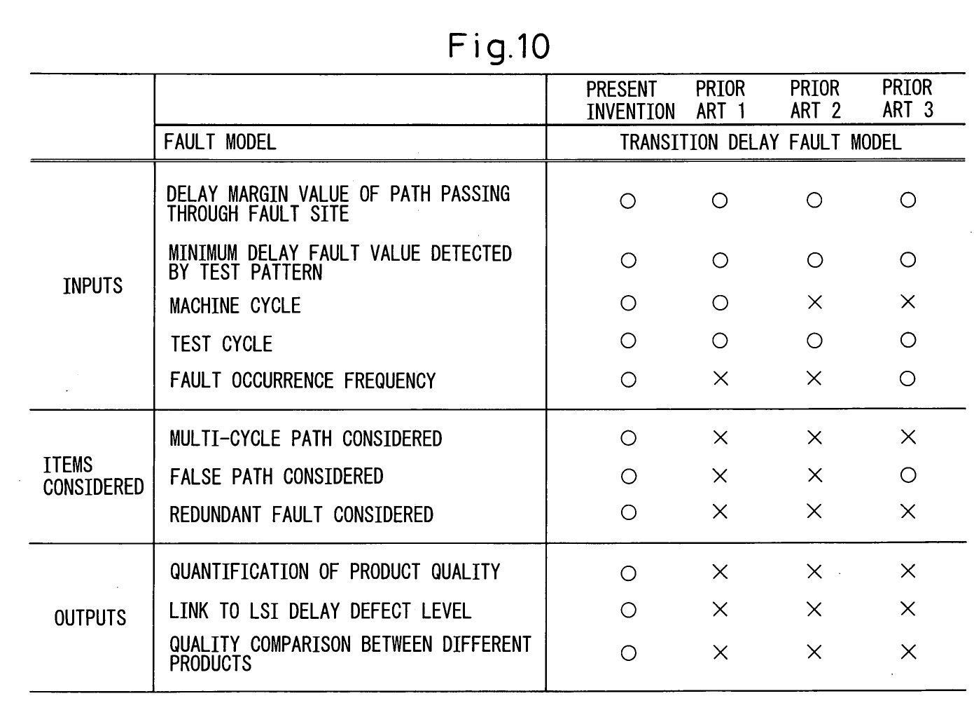

FIG. 9 is a diagram for schematically explaining an example of an indicator used in the circuit quality evaluation method according to the present invention, and FIG. 10 is a diagram showing a table presenting comparisons between the circuit quality evaluation method according to the present invention and the circuit (semiconductor integrated circuit) quality evaluation method according to the prior art. A path delay distribution such as shown in FIG. 7A is obtained from the path minimum delay margin Tmgn shown in FIG. 9, and a delay fault distribution such as shown in FIG. 7B is obtained from the delay fault occurrence frequency DFG.

As shown in FIG. 9, the circuit quality evaluation method of the present invention obtains the indicator (delay quality indicator) by taking as inputs the path minimum delay margin Tmgn and the machine cycle MC in the design quality information (delay value information) I1, the test cycle TC and the minimum delay value Tdet of the detected delay fault in the test accuracy information I2, and the delay fault occurrence frequency DFG in the process quality information I3. The delay quality indicator used in the present invention can be calculated even in the absence of the test cycle TC and the minimum delay value Tdet of the detected delay fault in the test accuracy information I2 (that is, before application of the test pattern).

The indicator value of the delay quality indicator of the present invention is related to the delay fault occurrence frequency and also to the concept called timing redundancy, and can be used to estimate the failure rate in the actual market. The indicator value of the delay quality indicator of the present invention is linked to the delay defect level of a semiconductor integrated circuit (circuit), and indicates the quality of the design; furthermore, the indicator can be used to compare quality between different products (models).

As previously described, a method that obtains an indicator for each fault site is proposed, for example, in the first to third prior art examples. There is also proposed a method that obtains an indicator for the entire circuit by taking the average of the indicators for multiple fault sites, that is, [Metric for entire circuit]=[Σ[Metric for every fault]/[Number of faults]. However, in the prior art, if the average is taken over the multiple fault sites to obtain the indicator for the entire circuit, the resulting indicator is not linked to the quality of the entire circuit. Further, in the prior art, there are such indicators that have a range of 0 to 1, but the indicator value itself is not directly linked to the quality.

On the other hand, the indicator (delay quality indicator) of the present invention is linked to the quality of the circuit (semiconductor integrated circuit) and, by taking the sum of the indicators for the respective fault sites, the indicator value linked to the quality of the entire circuit can be obtained. Further, by dividing the indicator value by the total number of assumed faults, the indicator value per assumed fault can be obtained. The semiconductor integrated circuit quality evaluation method according to the present invention is shown in the table of FIG. 10 for comparison with the first to third prior art examples.

The embodiments of the circuit quality evaluation apparatus and evaluation method according to the present invention will be described in detail below with reference to the accompanying drawings.

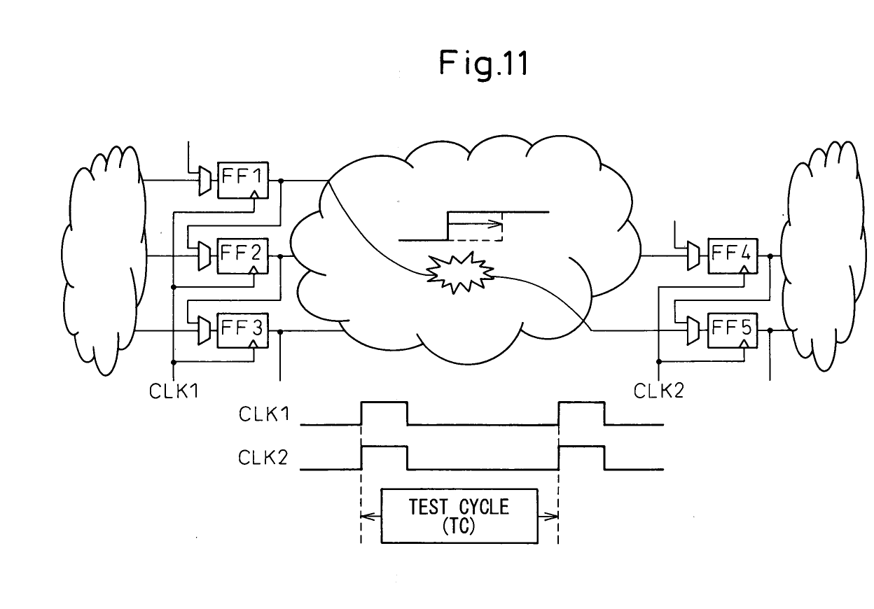

FIG. 11 is a diagram showing one example of a transition delay fault model in a circuit. The transition delay fault model is used here only in the sense that the fault site (input/output pin of a gate) and the type (falling or rising) are made the same as those in a transition fault model; as to the handling of the delay value, the delay value as defined in the present invention is used. Further, instead of a gate, a segment (a set of gates) may be taken as the assumed fault site.

As shown in FIG. 11, the transition delay fault model comprises, for example, flip-flops FF1 to FF3 which operate with a first clock CLK1, and flip-flops FF4 and FF5 which operate with a second clock CLK2, and a delay (gate delay fault) is assumed to exist at a gate input or output (rising or falling) in the circuit between the flip-flop FF1 and the flip-flop FF5. Here, for the first clock CLK1 and the second clock CLK2, the same clock may be used, as shown in FIG. 11, or different clocks may be used. The test cycle TC covers the time interval from the left-side rising timing of the first clock CLK1 to the right-side rising timing of the second clock CLK2. In a path passing through the fault site, signal transmission delay becomes large and the circuit may not function properly.

Next, path classification is performed.

First, there are many paths that pass through a signal line containing a given transition delay fault and, of these paths, the longest path is the path that has the largest delay value because of the structure of the circuit, but any path externally specified as a false path (a path not used in system operation) is excluded. Next, a tested path is a path sensitized when a test pattern is applied (the path is detectable if the delay fault is sufficiently large). The path delay value is calculated using, for example, a STA (Static Timing Analysis) tool or a SDF (Standard Delay Format).

A transition delay fault is assumed in the circuit (semiconductor integrated circuit); here, by analyzing the structure of the circuit, the longest path that passes through the transition delay fault site is identified. Further, by applying a test pattern and running a fault simulation, the tested path that passes through the transition delay fault site is identified.

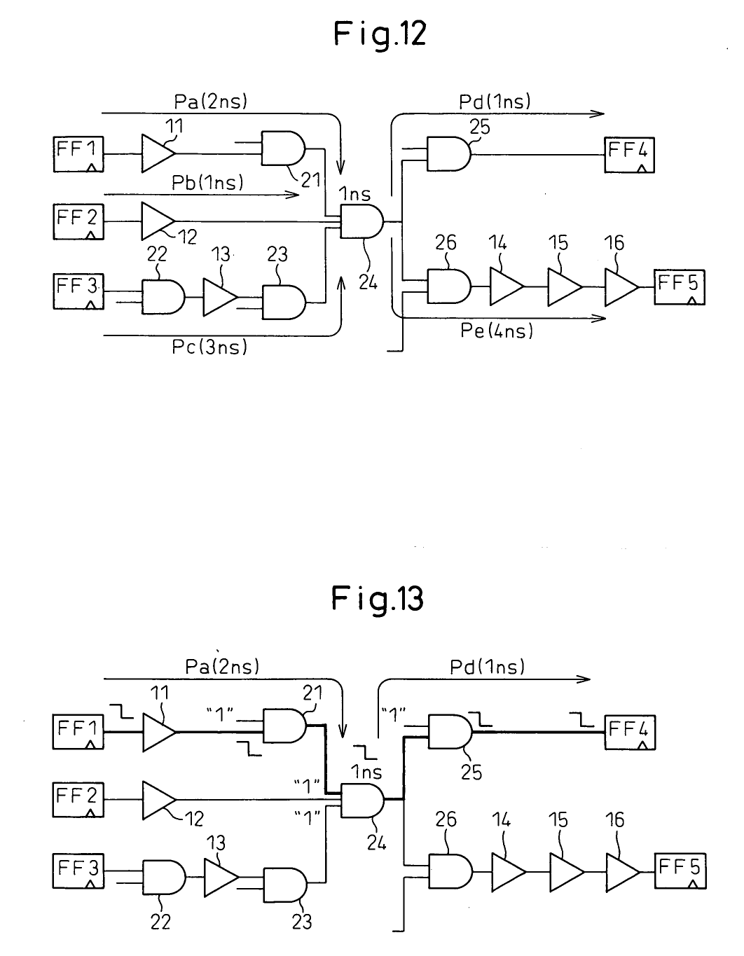

FIG. 12 is a diagram showing one example of a circuit implementing the transition delay fault model shown in FIG. 11; in this example, gates (buffers 11 to 16 and AND gates 21 to 26) are added to the respective flip-flops FF1 to FF5. It is assumed here that a falling transition delay fault exists on the output of the three-input AND gate 24.

First, it is assumed that the false path is given as the path that passes through the flip-flop FF3, the path Pc (AND gate 22, buffer 13, and AND gate 23), the AND gate 24, the path Pe (AND gate 26, buffer 14, buffer 15, and buffer 16), and the flip-flop FF5 (3 ns+1 ns+4 ns =8 ns) in the order stated.

Next, the longest path, excluding the false path, is the path that passes through the flip-flop FF3, the path Pc, the AND gate 24, the path Pd (AND gate 25), and the flip-flop FF5 (3 ns +1 ns+1 ns=5 ns) in the order stated. Further, it is assumed that the tested path is the path that passes through the flip-flop FF1, the path Pa (buffer 11 and AND gate 21), the AND gate 24, the path Pd (AND gate 25), and the flip-flop FF4 (2 ns+1 ns+1 ns=4 ns) in the order stated.

FIG. 13 is a diagram showing one example of the tested path in the circuit of FIG. 12.

First, a test pattern that causes a falling transition is applied to the flip-flip FF1. That is, a test pattern is applied that propagates the falling transition along the path passing through the path Pa, the AND gate 24, and the path Pd.

With the application of the test pattern satisfying the above condition, the falling transition delay fault is sensitized on the path (the flip-flop FF1, the path Pa, the AND gate 24, the path Pd, and the flip-flop FF4 in this order), and the resulting signal value is captured by the flip-flop FF4. The delay fault affects the timing (test cycle) that the signal value is captured by the flip-flop FF4.

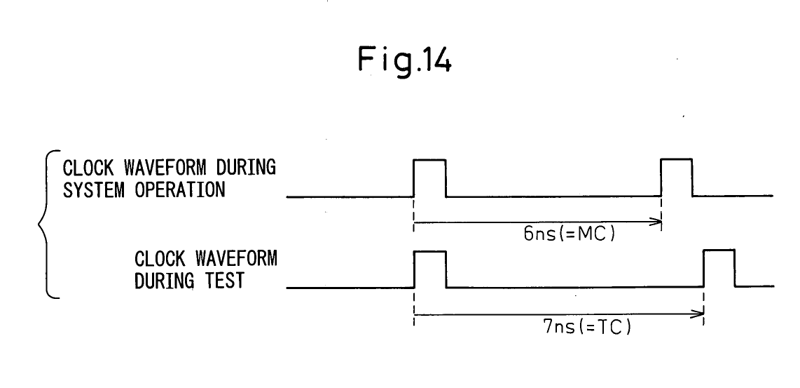

FIG. 14 is a diagram showing a clock waveform during system operation and a clock waveform during test operation.

As described above, the longest path is the path leading from the flip-flop FF3 to the flip-flop FF4 (5 ns), and the tested path is the path leading from flip-flop FF1 to the flip-flop FF4 (4 ns). It is assumed here that the flip-flops FF1 to FF5 belong to a signal clock domain, that the machine cycle is 6 ns, and that the test clock timing, i.e., the test cycle TC, is 7 ns.

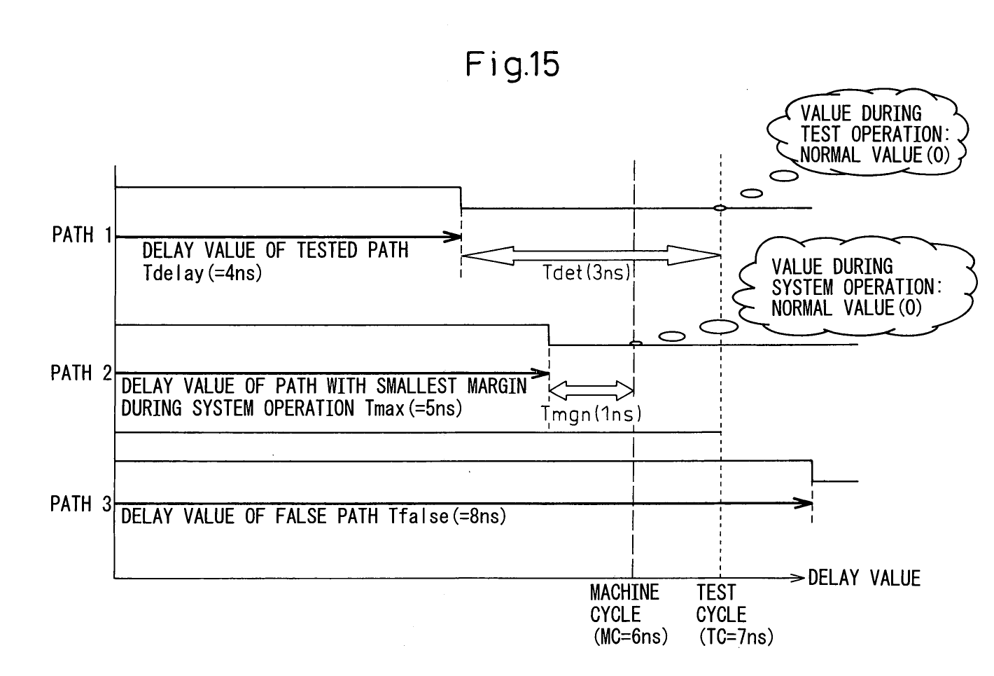

FIG. 15 is a diagram showing an example of a signal waveform in the absence of a fault.

As shown in FIG. 15, since the delay value of the tested path (the tested path delay value Tdelay) is 4 ns, the signal value at the end of the machine cycle MC (=6 ns) and the signal value at the end of the test cycle TC (=7 ns), in the absence of a fault, are both 0 which is a normal value. Here, the delay value of the longest path (the longest path delay value Tmax) is 5 ns, and the delay value of the false path is 8 ns.

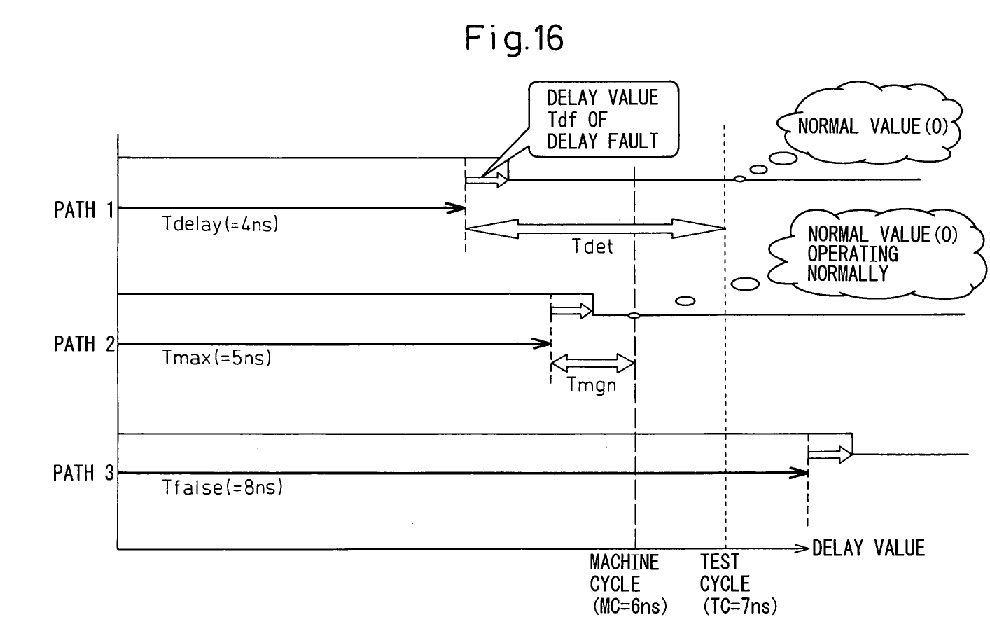

FIG. 16 is a diagram showing a first example of a signal waveform in the presence of a delay fault, that is, when a delay fault of 0.5 ns has occurred.

As shown in FIG. 16, if the delay value Tdf (0.5 ns) of the delay fault that has occurred is smaller than the time margin Tmgn allowed in the circuit (LSI) (Tdf<Tmgn), the delay fault is not detected and, since such a delay fault is within the range of the time margin Tmgn allowed in the circuit, the fault does not lead to a defect in actual use, nor does the actual market failure rate increase (the quality does not degrade).

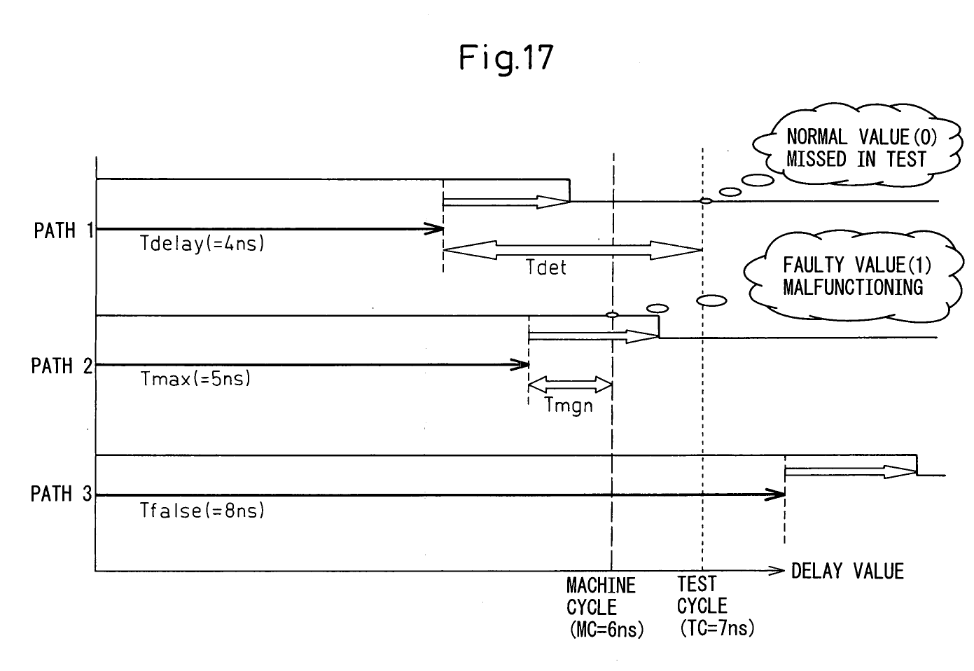

FIG. 17 is a diagram showing a second example of a signal waveform in the presence of a delay fault, that is, when a delay fault of 1.5 ns has occurred.

As shown in FIG. 17, if the delay value Tdf (1.5 ns) of the delay fault that has occurred is larger than the time margin Tmgn allowed in the circuit (LSI), but smaller than the detected minimum delay fault value (the delay margin of the tested path) Tdet (Tmgn<Tdf<Tdet), the delay fault goes undetected in the test, but since such a delay fault is outside the range of the time margin Tmgn allowed in the circuit, the fault leads to a defect in actual use, and the actual market failure rate therefore increases (the quality degrades).

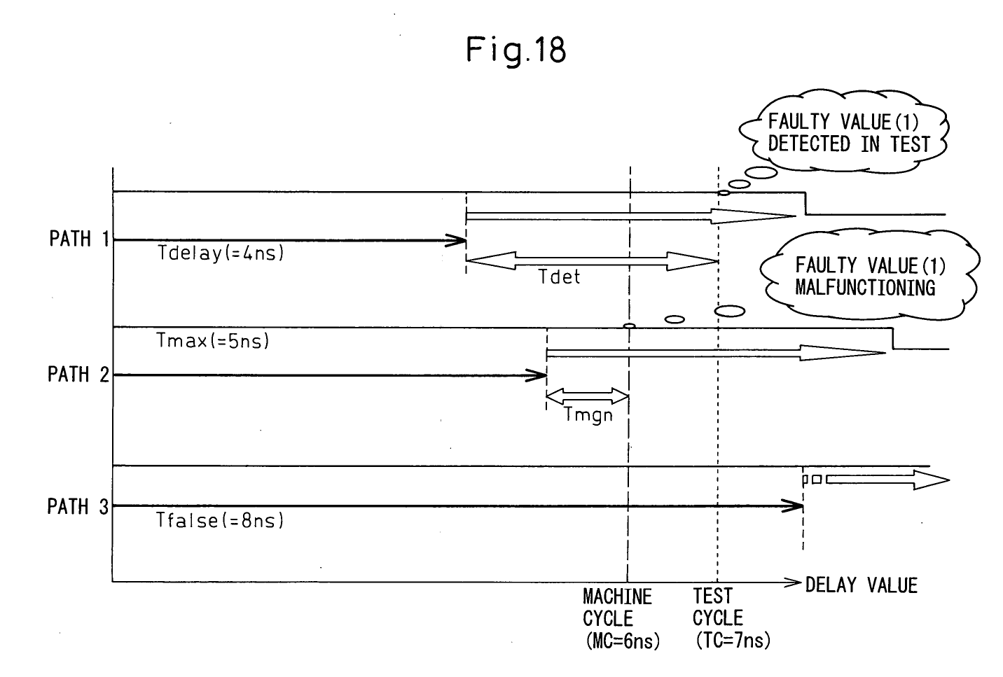

FIG. 18 is a diagram showing a third example of a signal waveform in the presence of a delay fault, that is, when a delay fault of 4 ns has occurred.

As shown in FIG. 18, if the delay value Tdf (4 ns) of the delay fault that has occurred is larger than the detected minimum delay fault value Tdet (Tdf>Tdet), the delay fault is detected, and the circuit (LSI) is rendered defective and is not shipped to the market; therefore, the actual market failure rate does not increase (the quality does not degrade).

Here, classification is performed according to the delay value of the fault.

First, the minimum delay margin Tmgn of the path is expressed as Tmgn=MC (Machine cycle)−Tmax (Longest path delay value). Here, in a multi-clock domain environment, when a path other than the longest path is sensitized, it may provide the minimum delay margin; therefore, in this specification, Tmgn is used, not Tmax. The detected minimum delay fault value Tdet is expressed as Tdet=TC (Test cycle)−Tdelay (Tested path delay value).

When the delay value Tdf of the transition delay fault is smaller than Tmgn, testing is not possible, and the circuit (LSI) is rendered defective and is not shipped to the market; therefore, the actual market failure rate does not increase (the quality does not degrade).

When Tmgn<Tdf<Tdet, the fault is not tested, and the defective circuit is not eliminated but is shipped to the market; as a result, the actual market failure rate increases (the quality degrades).

When Tdf>Tdet, the circuit is tested and rendered defective and is not shipped to the market; therefore, the actual market failure rate does not increase (the quality does not degrade).

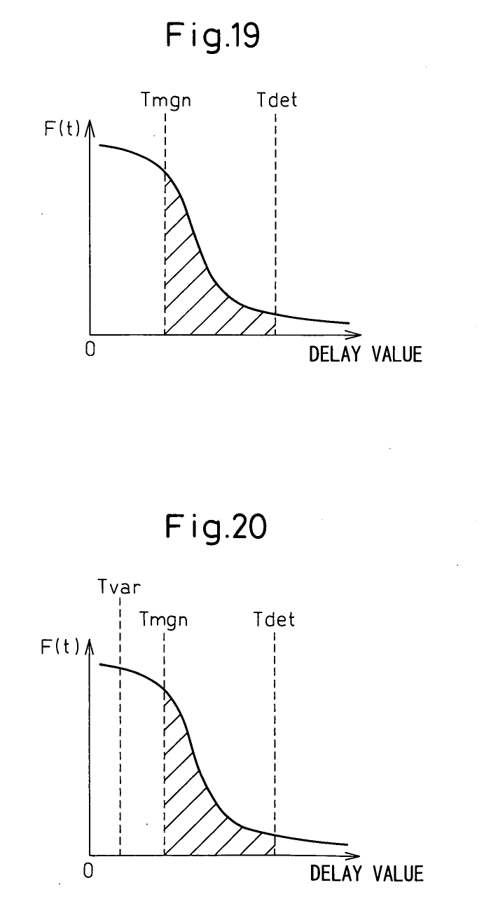

FIG. 19 is a diagram for explaining the delay quality indicator used in the circuit quality evaluation method according to the present invention.

First, the delay quality indicator for the entire circuit according to the present invention is given by the following equation, which corresponds to the hatched portion in FIG. 19.
Delay quality indicator=Σ[Delay quality indicator for every assumes fault]

$$= {\sum }_{K = 1}^{2 n} {\int }_{Tmgn ( Lnx )}^{Tdet ( Lnx )} F ( t ) ⅆ t$$

Here, n denotes the number of lines, Lnx denotes rising (R) and falling (F) delay faults on all lines, F(t) denotes the frequency of fault occurrence, Tdet(Lnx) denotes the minimum delay fault value detected for the fault Lnx, and Tmgn(Lnx) denotes the minimum delay margin of a path passing through the fault Lnx. When Tdet(Lnx)<Tmgn(Lnx), the value in the equation is assumed to be 0.

When the delay quality indicator is 0, the quality is high, and the quality decreases as the indicator value increases.
Delay quality indicator per assumed fault=

$$\begin{matrix}\frac{\sum [ Delay quality metric for every assumed fault ]}{Total number of faults} = \\ \frac{{\sum }_{k = 1}^{2 n} {\int }_{Tmgn ( Lnx )}^{Tdet ( Lnx )} F ( t ) ⅆ t}{2 n}\end{matrix}$$

As shown, by dividing the indicator by the total number of assumed faults, the delay quality indicator per assumed fault is obtained.

FIG. 20 is a diagram for explaining the delay quality indicator when path delay variation in the circuit is taken into account.

In the delay quality indicator according to the present invention, when path delay variation Tvar is taken into account, the delay quality indicator for the fault Lnx is given by the following equation, which corresponds to the hatched portion in FIG. 20. Delay quality indicator for fault Lnx=

$${\int }_{Tvar ( Lnx )}^{Tdet ( Lnx )}$$

F(t)dt

Generally, the path delay value in a circuit is prone to variation, and the circuit is designed with a certain degree of timing margin by taking the path delay variation Tvar into account.

When Tmgn≧Tvar, the delay quality indicator is obtained by the equation explained with reference to FIG. 19, and when Tmgn<Tvar, the delay quality indicator for the fault Lnx is obtained by the equation explained with reference to FIG. 20.

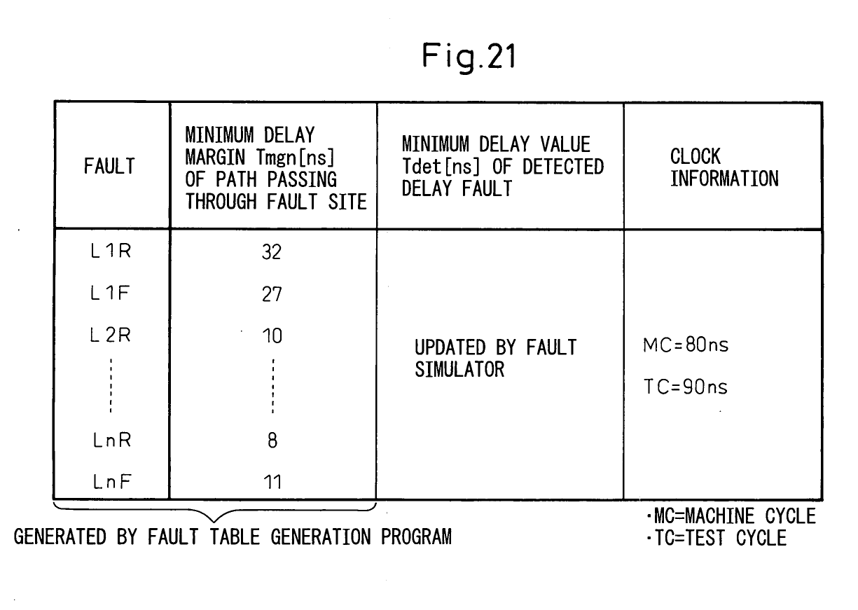

FIG. 21 is a diagram showing one example of a fault table in the circuit quality evaluation method according to the present invention.

As shown in FIG. 21, the path minimum delay margin Tmgn, detected minimum delay fault value Tdet, and clock information (machine cycle MC and test cycle TC) are generated for each fault in the fault table by using a fault table generation program. Here, L1R is a rising delay fault assumed on a first line, and L1F is a falling delay fault assumed on the first line; likewise, LnR is a rising delay fault assumed on the n-th line, and LnF is a falling delay fault assumed on the n-th line. The detected minimum delay fault value Tdet is sequentially updated by the fault simulator.

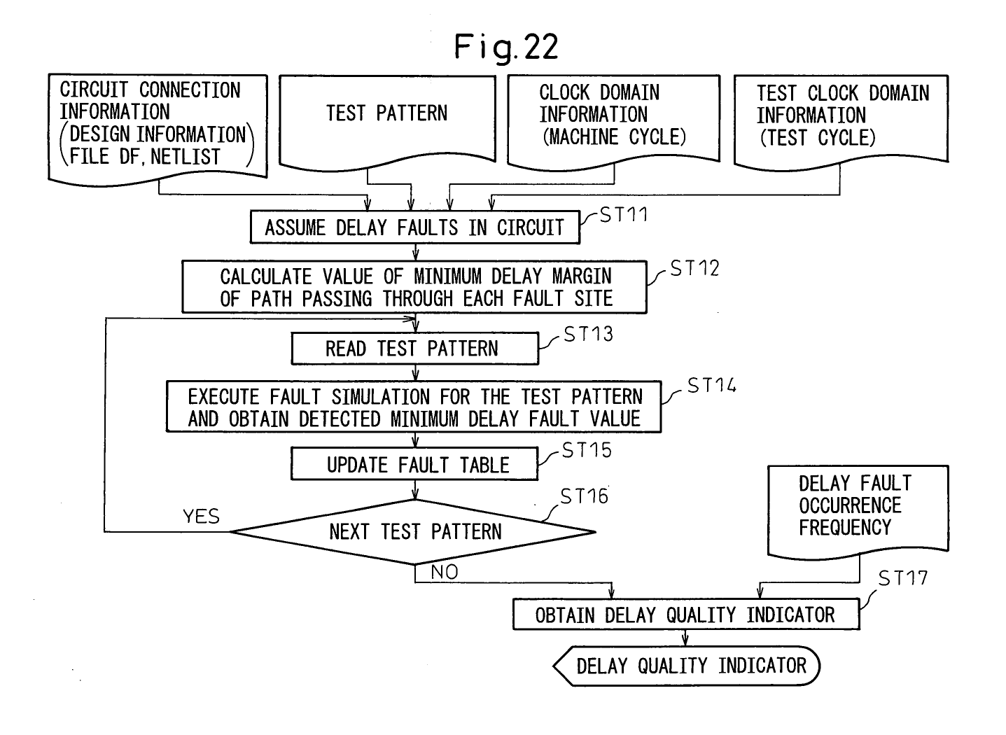

FIG. 22 is a diagram showing a flowchart for explaining one example of the circuit quality evaluation operation according to the present invention.

As shown in FIG. 22, first in step ST11, circuit connection information (that is, design information file, or netlist), test pattern (TP), clock domain information (machine cycle MC), and test clock domain information (test cycle TC) are input, and transition delay faults are assumed in the circuit; then, the process proceeds to step ST12 where the value of the minimum delay margin (Tmgn) is calculated for the paths passing through each assumed transition delay fault site.

Next, the process proceeds to step ST13 to read one test pattern, after which the process proceeds to step ST14. In step ST14, with the test pattern applied, the minimum delay value Tdet of the detected delay fault for each assumed transition delay fault site is calculated, after which the process proceeds to step ST15 to update the fault table such as explained with reference to FIG. 21.

Then, the process proceeds to step ST16; if there is the next pattern to read, the process returns to step ST13 to repeat the above steps, but if there is no next test pattern, the process proceeds to step ST17. In step ST17, the updated fault table and the delay defect occurrence frequency (DFG) are received, and the quality indicator (delay quality indicator) is obtained. Since the thus obtained delay quality indicator is proportional to the delay defect level corresponding to the actual market failure rate, the actual market failure rate can be estimated from the value of the delay quality indicator, as earlier described.

Here, the processing is performed by reading the test patterns one at a time, but alternatively, all the test patterns may be read at once, and then the assumed faults may be processed in sequence.

Generally, obtaining the path minimum delay margin Tmgn and the minimum delay value Tdet of the detected delay fault is a time-consuming process. On the other hand, for reasons on the part of the test conductors, it often happens that the test clock domain information (for example, the value of the test cycle TC) is changed. In view of this, when obtaining the quality indicator by only changing the test timing (the value of the test cycle TC), the indicator can be obtained faster if the test timing information is supplied in the quality indicator obtaining step ST17.

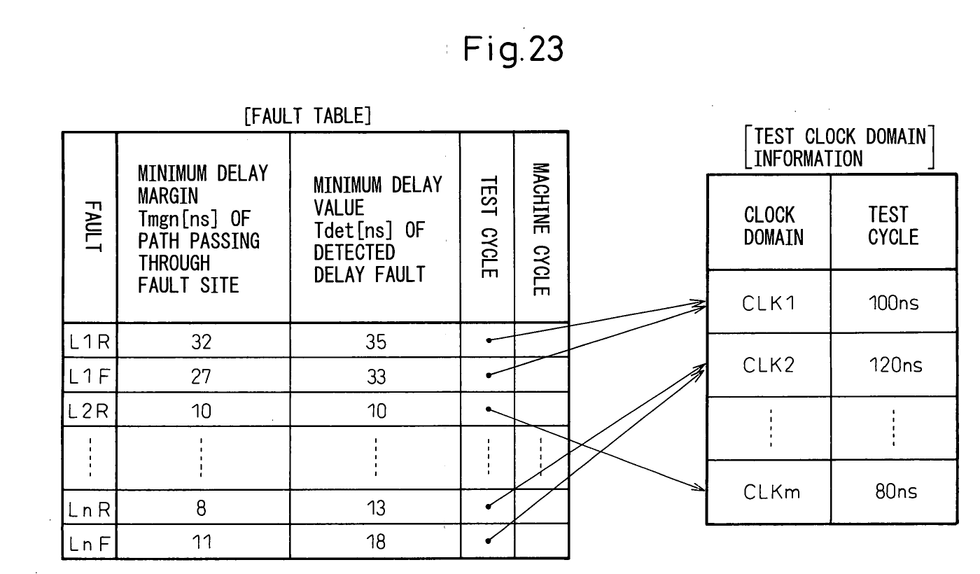

FIG. 23 is a diagram for explaining how the test timing is changed in the circuit quality evaluation method according to the present invention.

First, when the “test clock domain information” is supplied, the circuit structural information is analyzed to determine which fault belongs to which clock domain, and links are generated in the “test cycle” column in the fault table. Then, when changing the test timing, only the “test cycle” column in the “test clock domain information” is corrected, rather than applying the correction to the existing fault table itself.

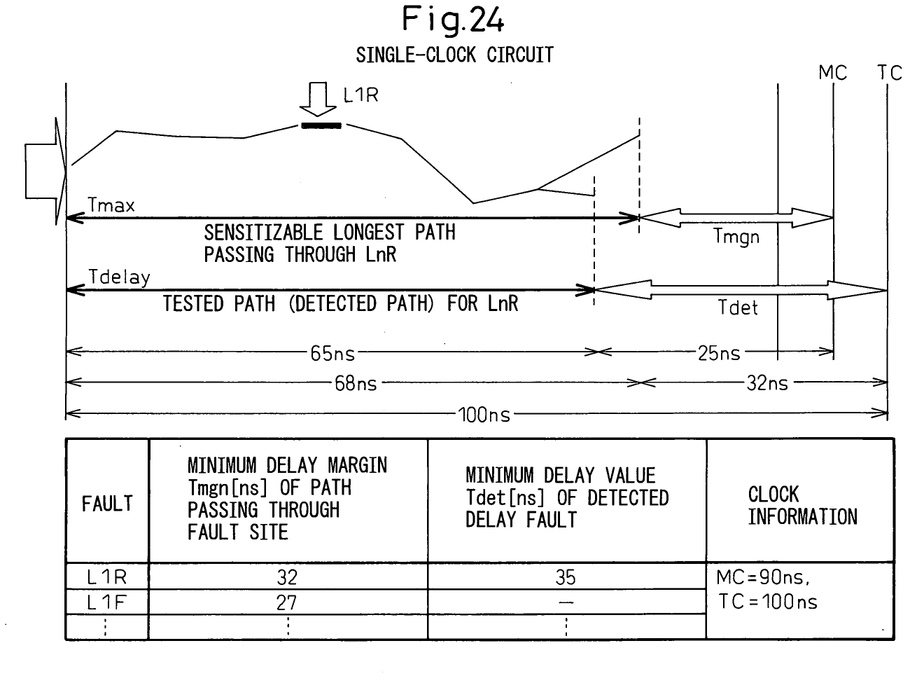

FIG. 24 is a diagram showing one example of a fault table for a single-clock circuit in the circuit quality evaluation method according to the present invention.

As shown in FIG. 24, in the fault table for the single-clock circuit, the path minimum delay margin Tmgn, for example, is 32 ns, the minimum delay value Tdet of the delay fault detected for the rising delay fault L1R assumed on the first line is 35 ns, the machine cycle MC is 90 ns, and the test clock cycle TC is 100 ns. At this point, L1F on the second line is not detected (because, for the test patterns so far applied, there is no sensitized path that passes through L1F); therefore, Tdet is not updated. In implementation of the program, by using a numeric value such as 0 or a negative value that is out of range of Tdet, the updating of Tdet is checked. If Tdet can be regarded as being the same as Tmgn, the processing for subsequent test patterns can be omitted by assuming that the fault has been dropped, as in the conventional fault simulation. In the single-clock circuit, the same clock information (machine cycle MC and test cycle TC) is used for the delay faults assumed on all lines (for example, the delay faults L1R and L1F on the first line to the delay faults LnR and LnF on the n-th line).

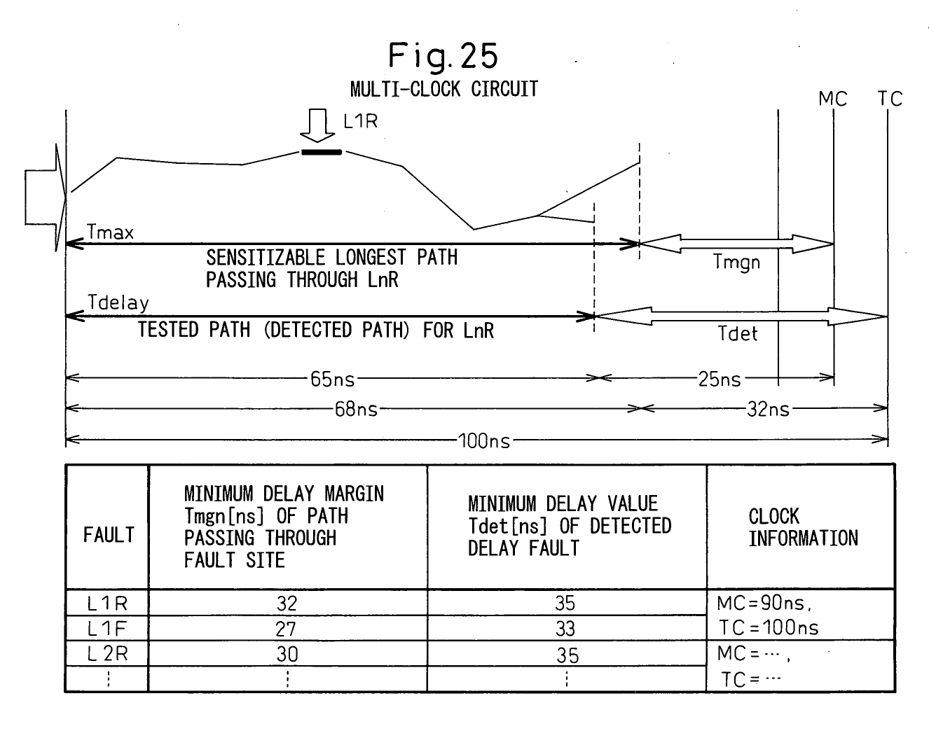

FIG. 25 is a diagram showing one example of a fault table for a multi-clock circuit in the circuit quality evaluation method according to the present invention.

As shown in FIG. 25, in the fault table for the multi-clock circuit, the path minimum delay margin Tmgn, for example, is 32 ns, the minimum delay value Tdet of the delay fault detected for the rising delay fault L1R assumed on the first line is 35 ns, the machine cycle MC is 90 ns, and the test clock cycle TC is 100 ns. In the multi-clock circuit, different clock information can be used for the delay faults assumed on the different lines to be tested (for example, the delay fault L1R on the first line and L2R on the third line); besides, different test clocks TC can be used for different types of delay fault, i.e., the rising delay fault and the falling delay fault, on the same line (for example, L1R and L1F).

Next, the delay quality indicator for the multi-clock circuit will be described.

Consider the case where there are n clocks (CLK1, CLK2, . . , CLKn) and there are m combinations of transmitting and receiving clocks (clock-1, clock-2, . . . , clock-m). Here, “clock” means a combination of a transmitting clock and a receiving clock, for example, “CLK1 (transmitting)→CLK1 (receiving)”, “CLK1 (transmitting)→CLK2 (receiving)”, and so on. However, since there are combinations not used because of design constraints, the total number m is smaller than the square of n. The minimum delay margin Tmgn of a path passing through a fault site can be obtained from the machine cycle MC specific to the transmitting/receiving combination for the path. Likewise, the minimum delay value Tdet of the detected delay fault can be obtained from the test clock information for the sensitized path. In this way, since each assumed fault can have the machine cycle and test cycle information independently of the others, the indicator can be calculated from the previously given equation in [MATHEMATICAL 5]. Here, since each individual indicator is related to the fault occurrence frequency, it follows that the indicator is related to the delay quality indicator for the entire circuit even when the circuit is of a multi-clock configuration.

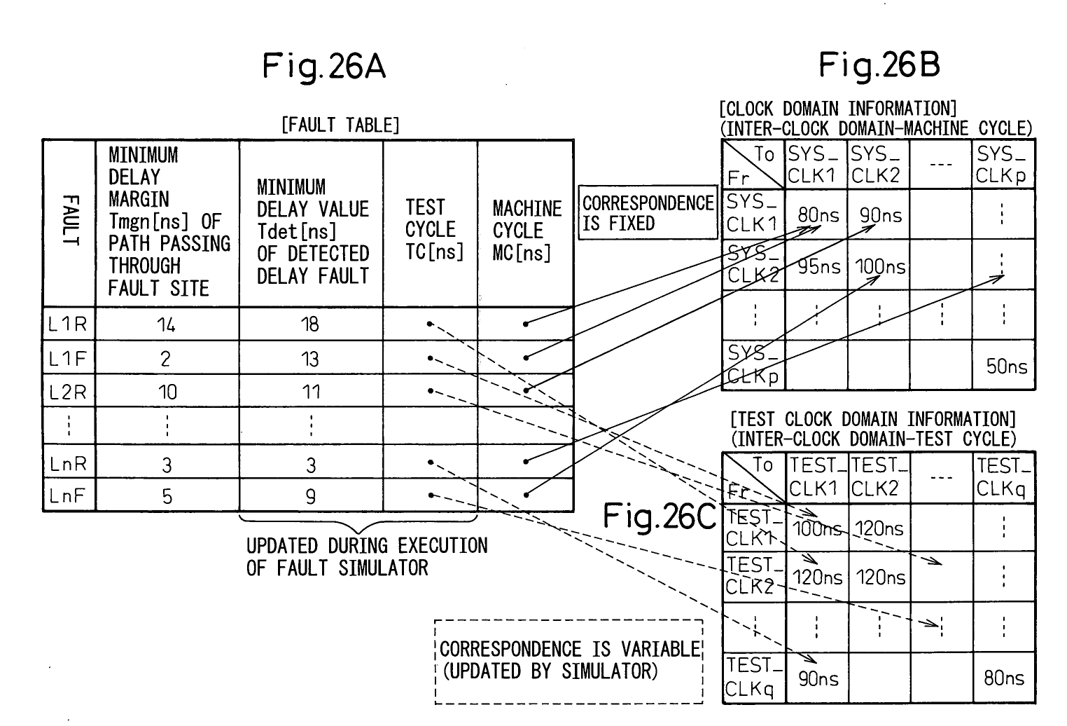

FIGS. 26A, 26B, and 26C are diagrams showing one example of correspondence between the fault table and the clock domain information and test clock domain information in the circuit quality evaluation method according to the present invention: FIG. 26A shows the fault table, FIG. 26B shows the clock domain information (inter-clock domain—machine cycle), and FIG. 26C shows the test clock domain information (inter-clock domain—test cycle).

As shown in FIG. 26A, the test cycle TC and the minimum delay value Tdet of the detected delay fault for each of the delay faults (L1R, L1F, L2R, . . . , LnR, LnF) assumed on the respective lines are updated during execution of the fault simulator. Further, as shown in FIGS. 26A and 26B, the machine cycle MC is fixed, and as shown in FIGS. 26A and 26C, the test cycle TC is variable (updated by the simulator).

As shown in FIGS. 26B and 26C, the clock domain information and the test clock domain information provide the machine cycle and the test cycle, respectively, for each ordered clock domain pair (from/to).

The “machine cycle” is defined by the value of the “clock domain information” that corresponds to the pair of clock domains at both ends of the path that has the minimum delay margin through each assumed fault site. This is shown by a link set up from the machine cycle column in FIG. 26A to the corresponding column in FIG. 26B, and this link is a fixed link.

For the test cycle and the minimum delay value of the detected delay fault, first the following value is calculated for each sensitized path.

(A): =Value of “test clock domain information” that corresponds to the pair of clock domains at both ends of the path−Path delay value

The smallest value of (A) among the values calculated for the sensitized paths is taken as the “minimum delay value Tdet of the detected delay fault”. The “test cycle” is defined by the value of the “test clock domain information” that corresponds to the pair of clock domains at both ends of the path for which the value of (A) is the smallest. This is shown by a link set up from the test cycle column in FIG. 26A to the corresponding column in FIG. 26C, and this link is variable (updated by the simulator).

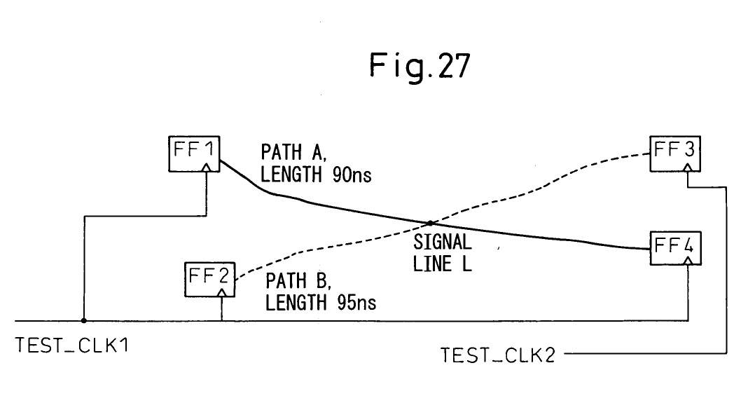

FIG. 27 is a diagram showing one example of the multi-clock circuit in the circuit quality evaluation method according to the present invention.

For a given signal line L, the combination of clock domains at both ends of a path A consists of TEST-CLK1 and TEST-CLK1; in this case, from FIG. 26C, (A)=100 ns −90 ns=10 ns. On the other hand, the combination of clock domains at both ends of a path B consists of TEST-CLK1 and TEST-CLK2; in this case, from FIG. 26C, (A)=120 ns−95 ns=25 ns.

As a result, the path A is selected, and therefore, the minimum delay value of the detected delay fault is 10 ns, and the test cycle is 100 ns. Here, if a value smaller than the current “minimum delay value of the detected delay fault” is obtained, the “minimum delay value of the detected delay fault” is updated to that value. If, at this time, the combination of clock domains at both ends of the “detected path” is different from the current one, the link to the “test clock domain information” is also updated.

False path in a narrower sense refers to a path not used during system operation. In a random pattern or the like that can sensitize such a false path, there can occur cases where the sensitizable path is longer than the test cycle. To address such cases, no changes are applied to the fault table but, in the case of a test pattern with output expected values, X mask is applied to the corresponding output expected value (if X mask is not possible, the value is rendered faulty so as not to be detected as a value).

A multi-cycle path is a path that operates with two or more clock cycles; if such a path is sensitized by a test pattern applied, X mask is applied to the corresponding expected value, as in the case of the false path (if X mask is not possible, the value is rendered faulty so as not to be detected as a value).

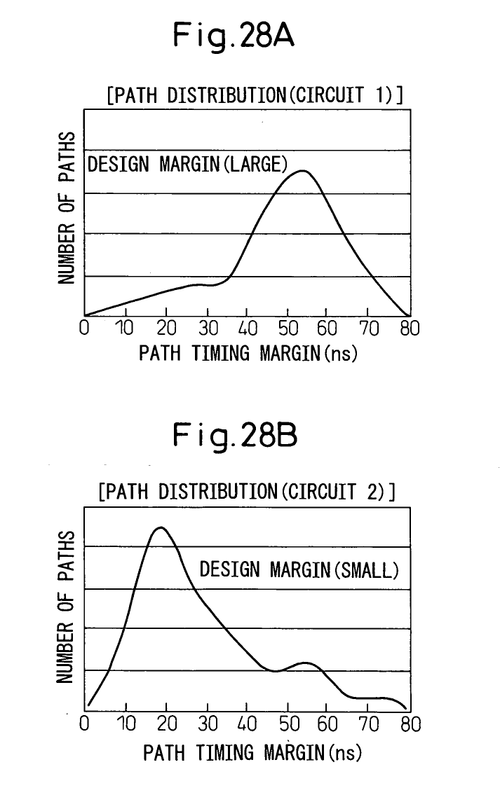

FIGS. 28A and 28B are diagrams each showing an example of a path distribution in an evaluation circuit in the circuit quality evaluation method according to the present invention: FIGS. 28A and 28B respectively show the examples of obtaining the delay quality indicators in two different kinds of evaluation circuits (circuit 1 and circuit 2) having different path distributions. The circuit 1 shown in FIG. 28A corresponds, for example, to the ASIC-type circuit having a large design margin previously described with reference to the upper left diagram in FIG. 8, and the circuit 1 shown in FIG. 28B corresponds, for example, to the processor-type circuit having a small design margin previously described with reference to the lower right diagram in FIG. 8.

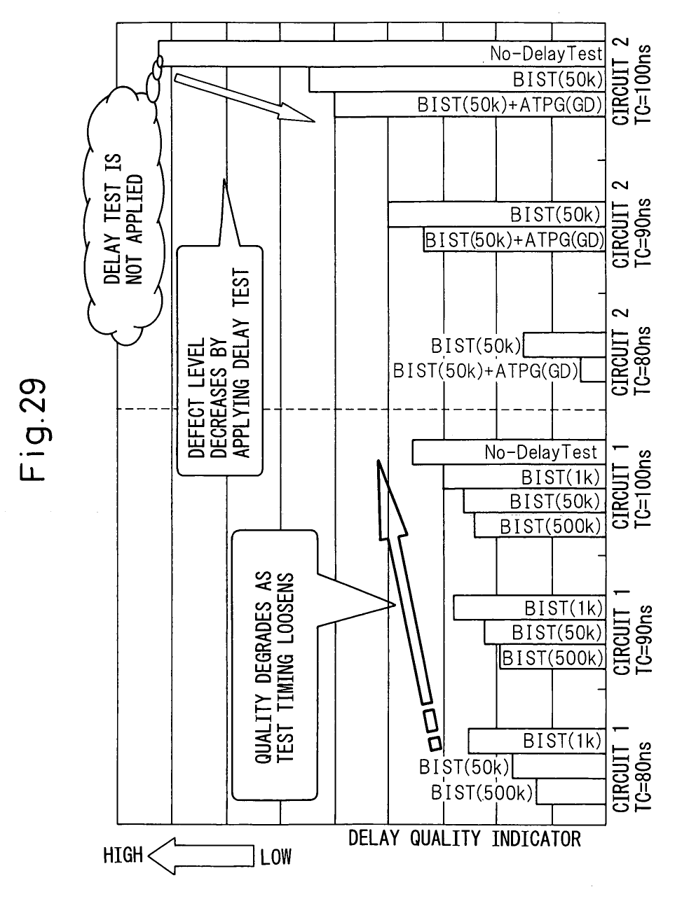

FIG. 29 is a diagram for explaining the delay quality indicator obtained in the circuit quality evaluation method according to the present invention.

As shown in FIG. 29, as the timing requirements of the design become more stringent (that is, as the design proceeds from circuit 1 having a large design margin to circuit 2 having a smaller design margin and further to circuit 3 having an even smaller design margin), the delay quality indicator (the delay defect level on the market) increases. Further, even in the same circuit, as the machine cycle MC actually used becomes faster (for example, when the machine cycle MC is changed from 90 ns to 80 ns), the delay quality indicator increases. When delay testing is not applied (NO-Delay Test), the delay quality indicator becomes much larger than when delay testing is applied, and it can be seen that the delay quality indicator clearly becomes smaller depending on the number of delay tests (that is, as the number of tests increases from BIST (1 k) to BIST (50 k) and to BIST (500 k)).

In this way, the indicator (delay quality indicator) used in the present invention can numerically represent the delay defect level (delay quality) of the circuit (semiconductor integrated circuit) in the actual market. Furthermore, the indicator used in the present invention not only can distinctly show the difference in delay quality arising from the difference in circuit design (the difference in deign margin), but also can reliably identify the difference in delay quality between the different quality levels that were shown as having the same fault coverage in the previously described prior art indicator. Further, the indicator used in the present invention can also clearly show the difference in delay quality arising from the difference in test cycle.

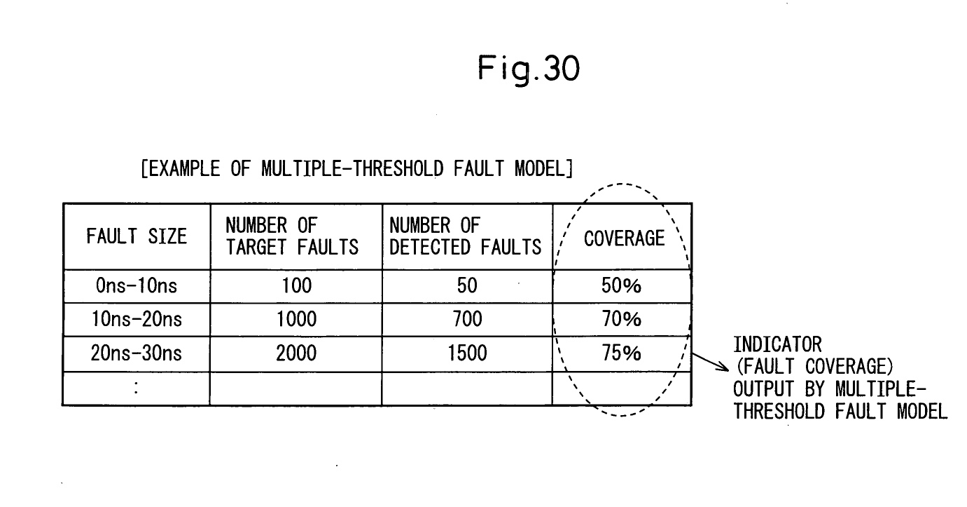

FIG. 30 is a diagram for explaining an example of a multiple-threshold fault model.

The circuit quality evaluation method of the invention described above is applied to the multiple-threshold fault model in which the fault sizes are classified into groups by using multiple thresholds (for example, 0 ns to 10 ns, 10 ns to 20 ns, 20 ns to 30 ns). The computation of the fault coverage using this multiple-threshold fault model is proposed in the prior art, but this fault coverage (indicator) is computed for each detectable fault size but the indicator does not represent the delay quality in the actual market.

In the present invention, the delay quality indicator from the multiple-threshold fault model is obtained by the following equation.

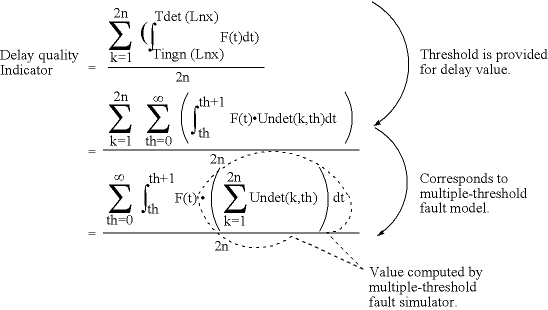

Here, Undet(k,th) is 0 if fault k is detected when its delay value is below th, and 1 if it is not detected.

That is, by applying the present invention to the prior art multiple-threshold fault simulator (multiple-threshold fault model), a high-speed simulation can be achieved, though the obtained result is an approximation. In this way, according to the present invention, the delay quality indicator can also be obtained using information output with multiple thresholds.

Next, the method of obtaining the delay fault occurrence frequency F(t) will be described.

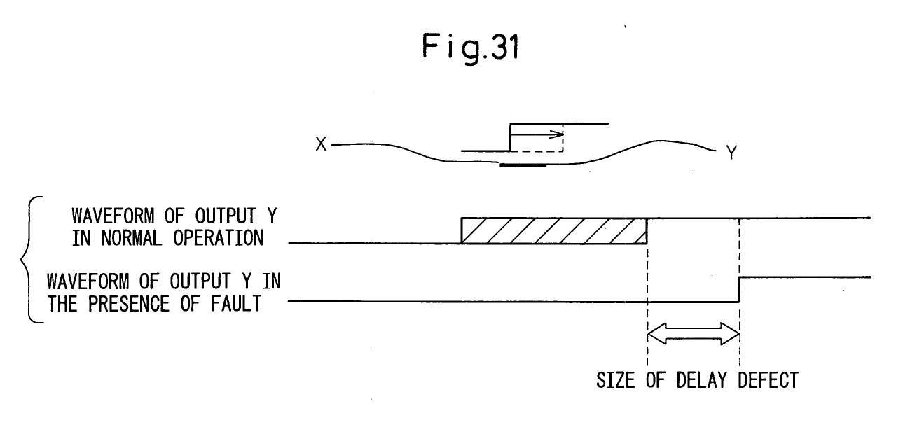

FIG. 31 is a diagram for explaining one example of the method of obtaining the delay fault occurrence frequency.

As shown in FIG. 31, assuming that a delay (gate delay fault) occurs on the path leading from an input X (corresponding, for example, to the output signal of the flip-flop FF1 in FIG. 11) to an output Y (corresponding, for example, to the input signal to the flip-flop FF5 in FIG. 11), the difference between the waveform of the output Y in system operation and the waveform of the output Y in the presence of the fault is referred to as the size of the delay fault.

To compute the distribution function of the delay fault occurrence frequencies, manufacturing defective circuits having delay faults are selected, the size of the delay fault is measured on each circuit, and the distribution function of the delay fault occurrence frequencies is statistically computed based on the obtained data.

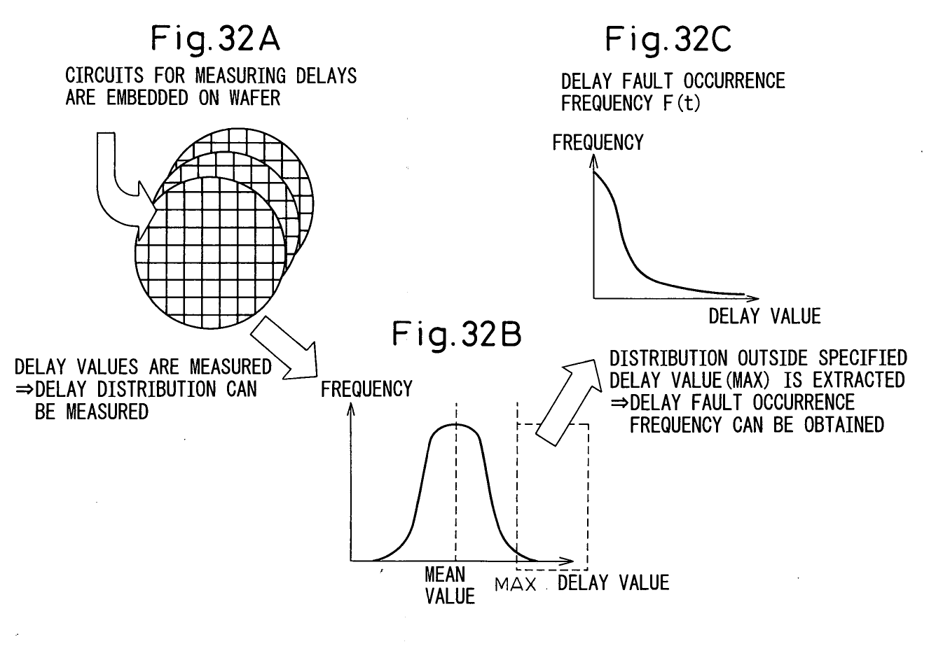

FIGS. 32A, 32B, and 32C are diagrams explaining another example of the method of obtaining the delay fault occurrence frequency.

First, as shown in FIG. 32A, dedicated circuits (for example, ring oscillators) for measuring delays are fabricated on the wafer, and as shown in FIG. 32B, circuit delay values are measured and the distribution of delay variations is obtained based on the obtained data. Then, as shown in FIG. 32C, the distribution outside the specified delay value (MAX) is extracted from the delay variation distribution of FIG. 32B, to obtain the delay fault occurrence frequency F(t).

The method of obtaining the delay fault occurrence frequency F(t) is not limited to the above two examples, but various other methods can be used.

In this way, according to the present invention, the indicator corresponding to the actual market failure rate can be obtained. Further, according to the present invention, not only does it become possible to compare quality between different kinds of semiconductor integrated circuits, but the accuracy can also be enhanced by accumulating data of the fault occurrence frequency for an IDM (Integrated Device Manufacturer).

Furthermore, according to the present invention, an indicator can be provided that reflects the quality of design (design margin), making it possible to quantify the relationship that a product having a larger margin is less prone to failure. Moreover, according to the present invention, an indicator can be provided that reflects the accuracy of test timing, making it possible to quantify the relationship between the improvement of timing accuracy and the improvement of quality.

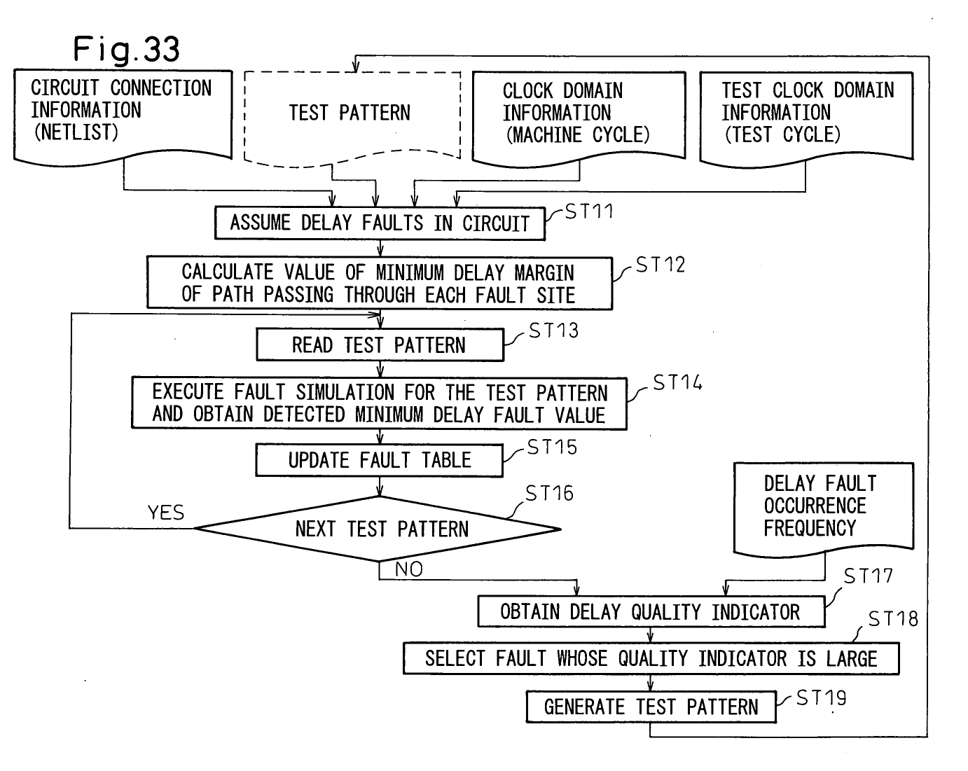

FIG. 33 is a diagram for explaining one example of test pattern generation that uses the delay quality indicator obtained in the circuit quality evaluation method according to the present invention.

As is apparent from a comparison of FIG. 33 with the previously given FIG. 22, FIG. 33 shows an example in which, after obtaining the delay quality indicator in step ST17 in the flowchart of FIG. 22, the test pattern is generated in steps ST18 and ST19 by using the delay quality indicator.

More specifically, after obtaining the delay quality indicator in step ST17 by receiving the updated fault table and the delay fault occurrence frequency (DFG), the process proceeds to step ST18 where a fault having a large delay quality indicator, i.e., a bad delay quality indicator, is selected from among the delay quality indicators for the detected faults.

Next, the process proceeds to step ST19 where the test pattern is generated by focusing attention on the fault selected in step ST18. This test pattern (TP) is input in step ST11 together with the netlist, the machine cycle MC, and the test cycle TC, and transition delay faults are assumed in the circuit; here, by feeding back the test pattern TP, it becomes possible to improve the delay quality indicator (that is, reduce the actual market failure rate).

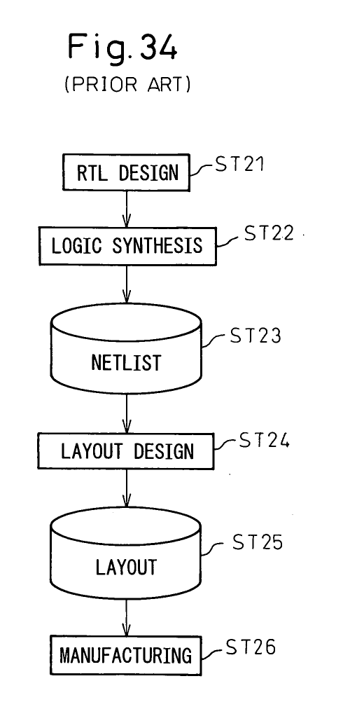

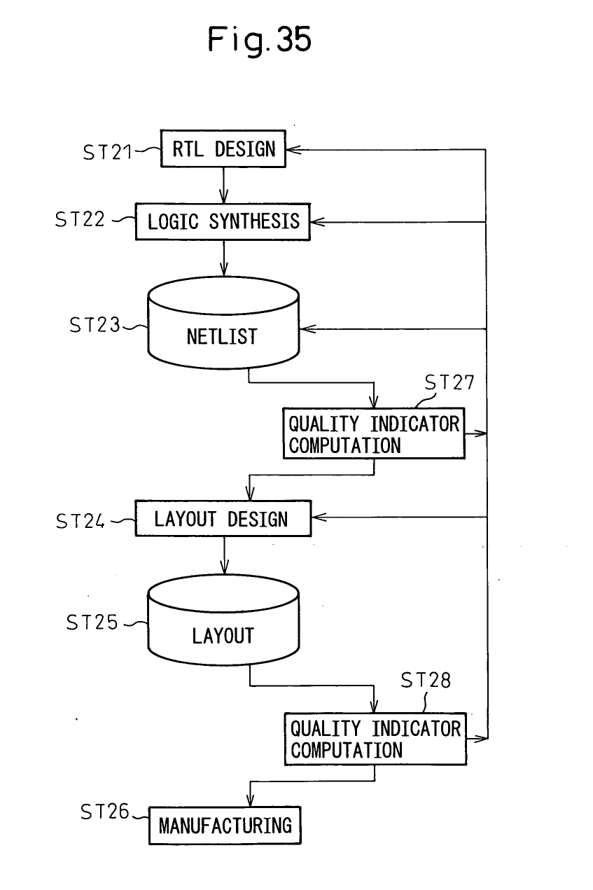

FIG. 34 is a diagram conceptually showing one example of a design flow according to the prior art, and FIG. 35 is a diagram for explaining one example of a design flow that uses the delay quality indicator obtained in the circuit quality evaluation method according to the present invention.

As shown in FIG. 34, in the prior art SoC (System on Chip) design flow, for example, after doing RTL (Register Transfer Level) design in step ST21, logic synthesis is performed using it in step ST22, and then the process proceeds to step ST23 to generate a netlist. Further, after doing layout design in step ST24, the layout is done in step ST25, and then the process proceeds to step ST26 where manufacturing is performed.

By contrast, in the design flow that uses the delay quality indicator obtained in the circuit quality evaluation method according to the present invention, in step ST28 the quality indicator (delay quality indicator) is computed from the layout done in step ST25, while in step ST27, the quality indicator (delay quality indicator) is computed using tentative wiring information as well as the netlist generated in step ST23. Here, the delay quality indicator computed in step ST28 can also be used, for example, to compare quality between different kinds of products, but the delay quality indicator computed in step ST27 is used to compare quality between products of the same kind.

The delay quality indicators obtained in steps ST27 and ST28 are fed back as constrained parameters or optimization parameters to the RTL design (ST21), logic synthesis (ST22), the netlist (ST23), or the layout design (ST24), thereby improving the delay quality indicators (to reduce the actual market failure rate) so that circuit design with low delay defect level can be achieved.

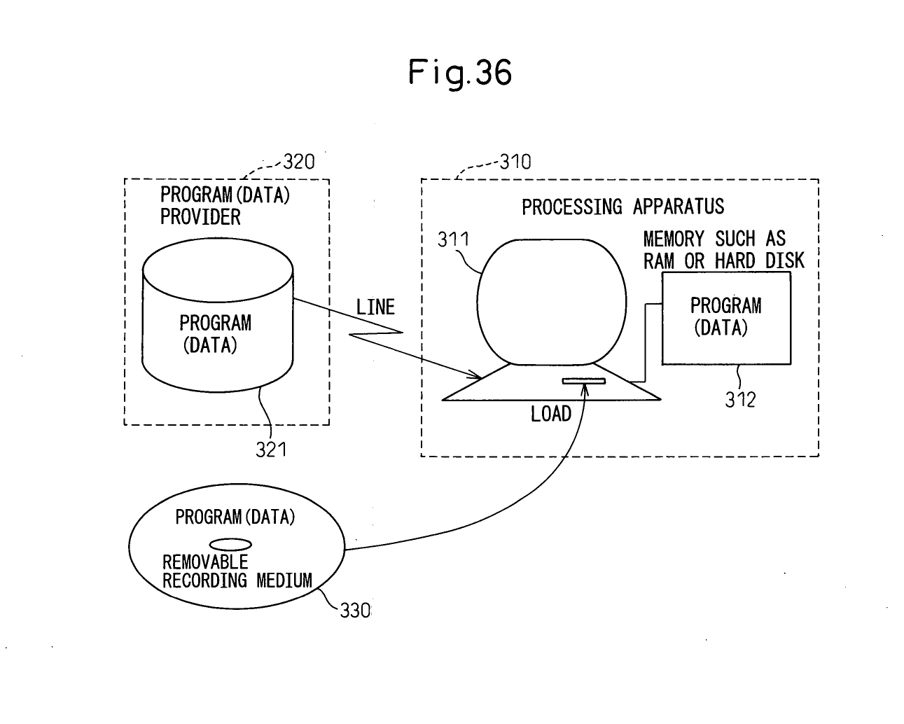

FIG. 36 is a diagram for explaining an example of a medium having a circuit quality evaluation program recorded thereon according to the present invention. In FIG. 36, reference numeral 310 is a processing apparatus, 320 is a program (data) provider, and 330 is a removable recording medium.

The circuit quality evaluation method according to each of the above embodiments is implemented, for example, in the form of a program (data) executable by the processing apparatus 310 such as shown in FIG. 36, and is carried out by the processing apparatus 310. The processing apparatus 310 comprises a processing apparatus main unit 311 containing a processor, and a processor-side memory 312 (for example, a RAM (Random Access Memory) or a hard disk) which provides the program (data) to the processing apparatus main unit 311 or stores processed results. The program (data) provided to the processing apparatus 310 is loaded into the main memory of the processing apparatus 310 for execution.

The program (data) provider 320 has a program (data) storing means (line-side memory: for example, DASD (Direct Access Storage Device) 321, and provides the program (data) to the processing apparatus 310, for example, via a line such as the Internet, or via the removable recording medium 330 which is an optical disk such as a CD-ROM or DVD or a magnetic disk such as a floppy disk. It will be appreciated that examples of the medium having the circuit quality evaluation program recorded thereon according to the present invention include the processor-side memory 312, the line-side memory 321, the removable recording medium 330, and various other kinds of media.

The present invention can be applied extensively to the technical field of circuit quality evaluation in which various kinds of circuits, such as semiconductor chips (dies) formed on a wafer, semiconductor integrated circuits constructed by packaging semiconductor chips, and multi-chip modules, circuit boards, or the like on which a plurality of LSIs are formed, are tested to evaluate the circuit quality. In particular, the delay quality indicator obtained by the present invention yields a value proportional to the delay defect level corresponding to the actual market failure rate associated with a delay fault in a semiconductor integrated circuit and, by applying this delay quality indicator, the actual market failure rate can be reduced drastically.

Many different embodiments of the present invention may be constructed without departing from the scope of the present invention, and it should be understood that the present invention is not limited to the specific embodiments described in this specification, except as defined in the appended claims.

1. A circuit quality evaluation method which obtains an indicator linked to the quality of a circuit by applying information representing a minimum delay margin of a path passing through an assumed fault site, a machine cycle, and a delay fault occurrence frequency, and evaluates the quality of said circuit based on said indicator.

2. The circuit quality evaluation method as claimed in claim 1, wherein said indicator is obtained by further applying test accuracy information.

3. The circuit quality evaluation method as claimed in claim 2, wherein said test accuracy information includes a minimum delay value of a detected delay fault for said fault site.

4. The circuit quality evaluation method as claimed in claim 3, wherein a plurality of said fault sites are assumed, and the same machine cycle and the same test cycle are used for said plurality of assumed fault sites.

5. The circuit quality evaluation method as claimed in claim 4, wherein an indicator linked to the quality of said circuit as a whole is obtained by summing the indicators computed for said plurality of assumed fault sites, and an indicator linked to the quality of said circuit per assumed fault site is obtained by taking an average of said indicators.

6. The circuit quality evaluation method as claimed in claim 5, wherein said indicators are obtained by taking account of variation in the minimum delay margin of the path passing through said assumed fault site.

7. The circuit quality evaluation method as claimed in claim 4, wherein an approximation to each of said indicators is obtained by using a multiple-threshold fault simulator.

8. The circuit quality evaluation method as claimed in claim 3, wherein a plurality of said fault sites are assumed, and a plurality of said machine cycles and a plurality of said test cycles are used for said plurality of assumed fault sites.

9. The circuit quality evaluation method as claimed in claim 8, wherein an indicator linked to the quality of said circuit as a whole is obtained by summing the indicators computed for said plurality of assumed fault sites, and an indicator linked to the quality of said circuit per assumed fault site is obtained by taking an average of said indicators.

10. The circuit quality evaluation method as claimed in claim 9, wherein said indicators are obtained by taking account of variation in the minimum delay margin of the path passing through said assumed fault site.

11. The circuit quality evaluation method as claimed in claim 8, wherein an approximation to each of said indicators is obtained by using a multiple-threshold fault simulator.

12. The circuit quality evaluation method as claimed in claim 2, wherein said test accuracy information includes a test cycle for said fault site.

13. The circuit quality evaluation method as claimed in claim 12, wherein a plurality of said fault sites are assumed, and the same machine cycle and the same test cycle are used for said plurality of assumed fault sites.

14. The circuit quality evaluation method as claimed in claim 13, wherein an indicator linked to the quality of said circuit as a whole is obtained by summing the indicators computed for said plurality of assumed fault sites, and an indicator linked to the quality of said circuit per assumed fault site is obtained by taking an average of said indicators.

15. The circuit quality evaluation method as claimed in claim 14, wherein said indicators are obtained by taking account of variation in the minimum delay margin of the path passing through said assumed fault site.

16. The circuit quality evaluation method as claimed in claim 13, wherein an approximation to each of said indicators is obtained by using a multiple-threshold fault simulator.

17. The circuit quality evaluation method as claimed in claim 12, wherein a plurality of said fault sites are assumed, and a plurality of said machine cycles and a plurality of said test cycles are used for said plurality of assumed fault sites.

18. The circuit quality evaluation method as claimed in claim 17, wherein an indicator linked to the quality of said circuit as a whole is obtained by summing the indicators computed for said plurality of assumed fault sites, and an indicator linked to the quality of said circuit per assumed fault site is obtained by taking an average of said indicators.

19. The circuit quality evaluation method as claimed in claim 18, wherein said indicators are obtained by taking account of variation in the minimum delay margin of the path passing through said assumed fault site.

20. The circuit quality evaluation method as claimed in claim 17, wherein an approximation to each of said indicators is obtained by using a multiple-threshold fault simulator.

21. A circuit quality evaluation method comprising the steps of:
applying circuit design information, a test pattern, clock domain information, and test clock domain information;
assuming a delay fault at a given site within a circuit;
calculating a minimum delay margin of a path passing through said assumed delay fault site;
calculating a minimum delay fault value detected on the path passing through said assumed delay fault site;
updating a fault table; and
obtaining a delay quality indicator by applying said updated fault table and a delay fault occurrence frequency, wherein the quality of said circuit is evaluated by estimating an actual market failure rate from the value of said obtained delay quality indicator.

22. The circuit quality evaluation method as claimed in claim 21, wherein the updating of said fault table is done by updating a minimum delay size of a detected delay fault and a test cycle during execution of a fault simulator.

23. The circuit quality evaluation method as claimed in claim 22, wherein said clock domain information includes a fixed machine cycle, and said test clock domain information includes said updated test cycle.

24. The circuit quality evaluation method as claimed in claim 23, wherein said delay fault is assumed at a plurality of sites, and the same machine cycle and the same test cycle are used for said plurality of assumed delay fault sites.

25. The circuit quality evaluation method as claimed in claim 24, wherein an indicator linked to the quality of said circuit as a whole is obtained by summing the delay quality indicators computed for said plurality of assumed delay fault sites, and a delay quality indicator linked to the quality of said circuit per assumed fault site is obtained by taking an average of said delay quality indicators.

26. The circuit quality evaluation method as claimed in claim 25, wherein said delay quality indicators are obtained by taking account of variation in the minimum delay margin of the paths passing through said plurality of assumed delay fault sites.

27. The circuit quality evaluation method as claimed in claim 24, wherein an approximation to each of said delay quality indicators is obtained by using a multiple-threshold fault simulator.

28. The circuit quality evaluation method as claimed in claim 23, wherein said delay fault is assumed at a plurality of sites, and a plurality of said machine cycles and a plurality of said test cycles are used for said plurality of assumed delay fault sites.

29. The circuit quality evaluation method as claimed in claim 28, wherein an indicator linked to the quality of said circuit as a whole is obtained by summing the delay quality indicators computed for said plurality of assumed delay fault sites, and a delay quality indicator linked to the quality of said circuit per assumed fault site is obtained by taking an average of said delay quality indicators.

30. The circuit quality evaluation method as claimed in claim 29, wherein said delay quality indicators are obtained by taking account of variation in the minimum delay margin of the paths passing through said plurality of assumed delay fault sites.

31. The circuit quality evaluation method as claimed in claim 28, wherein an approximation to each of said delay quality indicators is obtained by using a multiple-threshold fault simulator.

32. The circuit quality evaluation method as claimed in claim 21, wherein said test pattern is fed back by using said delay quality indicator.

33. The circuit quality evaluation method as claimed in claim 32, further comprising the steps of:
selecting a fault for which said delay quality indicator is large; and
generating a test pattern by focusing attention on said selected fault, and feeding back said generated test pattern to said information applying step.

34. The circuit quality evaluation method as claimed in claim 21, wherein feedback is applied to each design flow process by using said delay quality indicator.

35. The circuit quality evaluation method as claimed in claim 34, wherein said delay quality indicator is fed as a constrained parameter or an optimization parameter to an RTL design step, a logic synthesis step, a netlist generation step, or a layout design step.

36. A circuit quality evaluation apparatus which obtains an indicator linked to the quality of a circuit by applying information representing a minimum delay margin of a path passing through an assumed fault site, a machine cycle, and a delay fault occurrence frequency, and evaluates the quality of said circuit based on said indicator.

37. A circuit quality evaluation apparatus comprising:
means for applying circuit design information, a test pattern, clock domain information, and test clock domain information;
means for assuming a delay fault at a given site within a circuit;
means for calculating a minimum delay margin of a path passing through said assumed delay fault site;
means for calculating a minimum delay fault value detected on the path passing through said assumed delay fault site;
means for updating a fault table; and
means for obtaining a delay quality indicator by applying said updated fault table and a delay fault occurrence frequency, wherein the quality of said circuit is evaluated by estimating an actual market failure rate from the value of said obtained delay quality indicator.

38. A circuit quality evaluation program comprising the steps of:
applying circuit design information, a test pattern, clock domain information, and test clock domain information;
assuming a delay fault at a given site within a circuit;
calculating a minimum delay margin of a path passing through said assumed delay fault site;
calculating a minimum delay fault value detected on the path passing through said assumed delay fault site;
updating a fault table; and
obtaining a delay quality indicator by applying said updated fault table and a delay fault occurrence frequency, wherein the quality of said circuit is evaluated by estimating an actual market failure rate from the value of said obtained delay quality indicator.

39. A computer readable recording medium having a circuit quality evaluation program recorded thereon, said program comprising the steps of:
applying circuit design information, a test pattern, clock domain information, and test clock domain information;
assuming a delay fault at a given site within a circuit;
calculating a minimum delay margin of a path passing through said assumed delay fault site;
calculating a minimum delay fault value detected on the path passing through said assumed delay fault site;
updating a fault table; and
obtaining a delay quality indicator by applying said updated fault table and a delay fault occurrence frequency, wherein the quality of said circuit is evaluated by estimating an actual market failure rate from the value of said obtained delay quality indicator.
